(19) United States
(12) Patent Application Publication
(10) Pub. No.: US 2018/0142137 A1
(43) Pub. Date: May 24, 2018

(54) AGGREGATING COMPOSITIONS, MODIFIED PARTICULATE SOLID COMPOSITIONS, AND METHODS FOR MAKING AND USING SAME

(71) Applicant: Lubrizol Oilfield Solutions, Inc., Wickliffe, OH (US)

(72) Inventors: Duane S. TREYBIG, Spring, TX (US); Leonid VIGDERMAN, Houston, TX (US); Rajesh K. SAINI, Houston, TX (US)

(21) Appl. No.: 15/568,015

(22) PCT Filed: May 27, 2016
(86) PCT No.: PCT/US2016/034513

§ 371 Date: Oct. 20, 2017

Related U.S. Application Data
(60) Provisional application No. 62/166,723, filed on May 27, 2015.

(51) Int. Cl. C09K 8/575; C09K 8/57; C09K 8/80; E21B 43/02

(52) U.S. Cl. CPC C09K 8/5751; E21B 43/025; C09K 8/80; C09K 8/572

(57) ABSTRACT

An aggregating composition for altering surface properties including reaction products of amines, polyamines, and/or amine polymers and acidic hydroxyl containing compounds and/or Lewis acids, or mixtures and combinations thereof, where the compositions form partial or complete coatings on solid materials altering an aggregating propensity and/or zeta portion of the surfaces for downhole operations. A method for treating solid materials including contacting the materials with the aggregating composition in downhole operations. Treated solid materials including partial or complete coating comprising the aggregating composition for use in downhole operations.

### BACKGROUND OF THE INVENTION

### 1. Field of the Invention

The present invention relates to aggregating agents for solid materials or substrates including metal oxide or ceramic solid materials or substrates (natural or synthetic), metallic solid materials or substrates, polymeric or plastic solid materials or substrates (natural or synthetic), solid plant materials or substrates (natural or treated), or other types of solid materials or substrates and methods for making and using same.

More particularly, the present invention relates to aggregating agents for particulate solid materials or substrates, where the aggregating agents modify surface properties of the particulate solid materials increasing their aggregating propensity or properties, where the aggregating agents include reaction products of at least one nitrogen-containing compound and at least one amine reactive compound and mixtures or combinations. The present invention also relates to coated or modified particulate solid materials capable of self-aggregation, where the coating comprising the aggregating agents of this invention. The present invention also relates to methods for aggregating particulate solid materials, especially in downhole applications and in any other application, where particulate metal oxide-containing solids aggregation is desirable and where the coating comprising the aggregating agents of this invention.

### 2. Description of the Related Art

In many situations, sand, particulate metal oxide-containing solids or other particulate materials or solid materials are difficult to consolidate in underground formations once placed due to their inability to aggregate or to cling to each other or to form aggregated masses that allow formation fluid flow back through the placed or pumped-in fluids without flowing solids back to the surface. In addition, other situations occur where formation sand flows due to formation unconsolidated characteristics, and the flowing sand is transported to the surface during well production.

Although several technologies now exist for tackifying such particulate solid with a tackifying agent, there is a need in the art of a different treating composition to cause such particulate solids to self-aggregate and for methods for making self-aggregating particulate solids.

### SUMMARY OF THE INVENTION

### Aggregating Compositions

The present invention provides aggregating compositions including reaction products of at least one nitrogen-containing compound and at least one amine reactive compound and mixtures or combinations. The nitrogen-containing compounds include: (a) one amine or a plurality of amines, (b) one epoxy-modified amine or a plurality of epoxy-modified amines, (c) one oligomeric amine (oligoamine) or a plurality of oligomeric amines (oligoamines), (d) one epoxy-modified oligoamine or a plurality of epoxy-modified oligoamines, (e) one polymeric amine (polyamine) or a plurality of polymeric amines (polyamines), (f) one epoxy-modified polyamine or a plurality of epoxy-modified polyamines, (g) one amine containing polymer or a plurality of amine containing polymers, (h) one epoxy-modified amine containing polymer or a plurality of epoxy-modified amine containing polymers; (i) one reaction product of at least one epoxy containing compound and at least one nitrogen-containing compound or a plurality of reaction products of at least one epoxy containing compound and at least one nitrogen-containing compound; (j) one biopolymer or a plurality of biopolymers, (k) one epoxy-modified biopolymer or a plurality of epoxy-modified biopolymers, and (l) mixtures or combinations. The amine reactive compound can additionally include: (1) an acid containing compound that forms a negative charge upon deprotonation, such as, for example, acidic nitrogen containing compounds, or one acidic hydroxyl containing compound or a plurality of acidic hydroxyl containing compounds, (2) one homo and mixed anhydride of acidic hydroxyl containing compounds or a plurality of homo and mixed anhydride of acidic hydroxyl containing compounds; (3) one Lewis acid or a plurality of Lewis acids, (4) one phosphate-containing compound or a plurality of phosphate-containing compounds, or (5) mixtures and combinations thereof, where the phosphate-containing compounds is used in conjunction with one of the other amine reactive compounds. The compositions of this invention are capable of modifying, augments, and/or altering an aggregating propensity and/or zeta potential of solid materials by forming a partial or complete coating on the solid materials. In certain embodiments, the coatings are deformable allowing fluid flow to rearrange the aggregated particles coating with the aggregating compositions of this invention to more effectively form flow channels through a formation. The aggregating compositions can also include a crosslinking agent. The aggregating composition can additionally include resin.

### Coated Solids

The present invention provides a particulate solid material such as a metal oxide-containing solid having improved self-aggregating properties, where the particulate solid materials include a partial or complete coating comprising an aggregating composition of this invention. The improved self-aggregating or aggregation propensity or modified zeta potential of the particles derives from the surfaces of the particulate solids having a partial or complete coating including an aggregating composition of this invention. The coating formed on the particles by the compositions of this invention are capable of deforming under pressure and imparts an enhanced aggregating propensity to the solid particles.

### Coating Substrates

The present invention provides a substrate having surfaces partially or completely coated with a composition of this invention, where the coating is deformable and where the substrate is ideally suited for filtering fines and/or other particulate materials from a fluid, especially fluids used in oil/gas well drilling, completion, production, fracturing, propping, other production enhancing processes or other related applications. The structures may be formation surfaces, screen surfaces, surfaces of ceramic structures or ceramic fiber structures, surfaces of sand and/or gravel used in grave and sand pack structure, where the surfaces are coated partially or completely with the compositions of this invention. Such structures are well suited for filter media to be used with or without screens in downhole operations.

### Method for Treating

The present invention provides a method for modifying, altering, and/or changing an aggregation potential or propensity or zeta potential of a solid material such as a metal oxide-containing solid, formation fines, formation surfaces, and downhole equipment surfaces, where the method includes the step of contacting the solid material with an aggregating composition of this invention to form a partial or complete coatings on surfaces of the solid material. In certain embodiments, the aggregating compositions of this invention are pumped downhole as unreacted components, where under conditions are sufficient for the components to react forming the reaction products of this invention and in turn forming the partial or complete coatings on surfaces of the solid material.

### Methods for Using the Treating Methods

Fracturing

The present invention provides a method for fracturing a formation including the step of pumping a fracturing fluid including a proppant into a producing or injection formation at a pressure sufficient to fracture the formation and to enhance productivity or injection efficiency, where the proppant props open formation fractures formed during fracturing and where the proppant comprises a particulate solid pre-treated with an aggregating composition of this invention under conditions sufficient to form a partial or complete coating on surfaces of particulate solid material. In certain embodiments, the fracturing fluid may include the components of the aggregating composition and the downhole conditions are sufficient for the components to form the reaction products of this invention and then forming the partial or complete coating on the proppant and surfaces of particulate solid materials.

The present invention provides a method for fracturing a formation including the step of pumping a fracturing fluid including a proppant and an aggregating composition of this invention into a producing or injection formation at a pressure sufficient to fracture the formation and to enhance productivity or injection efficiency. The composition results in a modification, alteration, and/or change of an aggregation propensity and/or zeta-potential of the proppant, formation particles, and formation surfaces so that the formation particles and/or proppant aggregate and/or cling to the formation surfaces.

The present invention provides a method for fracturing a formation including the step of pumping a fracturing fluid including an aggregating composition of this invention into a producing formation at a pressure sufficient to fracture the formation and to enhance productivity. The composition results in a modification of an aggregation propensity, potential and/or zeta-potential of the formation particles and formation surfaces so that the formation particles aggregate and/or cling to the formation surfaces. The method can also include the step of pumping a proppant comprising a coated particulate solid composition of this invention after fracturing so that the coated particles prop open the fracture formation and tend to aggregate to the formation surfaces and/or formation particles formed during fracturing.

Drilling

The present invention provides a method for drilling including the step of while drilling, circulating a drilling fluid, to provide bit lubrication, heat removal and cutting removal, where the drilling fluid includes an aggregating composition of this invention. The composition increases an aggregation potential or propensity and/or alters a zeta potential of any particulate metal oxide-containing solid in the drilling fluid or that becomes entrained in the drilling fluid to increase solids removal. The method can be operated in over-pressure conditions or under-balanced conditions or under managed pressure conditions. The method is especially well tailored to under-balanced or managed pressure conditions.

The present invention provides a method for drilling including the step of while drilling, circulating a first drilling fluid to provide bit lubrication, heat removal and cutting removal. Upon encountering an underground structure that produces undesirable quantities of particulate solids, changing the first drilling fluid to a second drilling fluid including a composition of this invention to provide bit lubrication, heat removal and cutting removal and to increase an aggregation potential or decrease the absolute value of the zeta potential of any particulate solids in the drilling fluid or that becomes entrained in the drilling fluid to increase solids removal. The method can be operated in over-pressure conditions or under-balanced conditions or under managed pressure conditions. The method is especially well tailored to under-balanced or managed pressure conditions.

The present invention provides a method for drilling including the step of while drilling, circulating a first drilling fluid to provide bit lubrication, heat removal and cutting removal. Upon encountering an underground structure that produces undesirable quantities of particulate solids, changing the first drilling fluid to a second drilling fluid including a composition of this invention to provide bit lubrication, heat removal and cutting removal and to increase an aggregation potential or decrease in the absolute value of the zeta potential of any particulate solids in the drilling fluid or that becomes entrained in the drilling fluid to increase solids removal. After passing through the structure that produces an undesired quantities of particulate solids, change the second drilling fluid to the first drilling fluid or a third drilling fluid. The method can be operated in over-pressure conditions or under-balanced conditions or under managed pressure conditions. The method is especially well tailored to under-balanced or managed pressure conditions.

Completion

The present invention provides a method for completing the step of circulating and/or pumping a fluid into a well on production, where the fluid includes an aggregating composition of this invention, which increases an aggregation potential or decreases the absolute value of the zeta potential of any particulate solid in the fluid or that becomes entrained in the fluid to increase solid particle removal and to decrease the potential of the particles to plug the formation and/or the production tubing.

Producing

The present invention provides a method for producing including the step of circulating and/or pumping a fluid into a well on production, where the fluid includes an aggregating composition of this invention, which increases an aggregation potential or decreases the absolute value of the zeta potential of any particulate solid in the fluid or that becomes entrained in the fluid to increase solid particle removal and to decrease the potential of the particles to plug the formation and/or the production tubing.

The present invention also provides a method for controlling sand or fines migration including the step of pumping a fluid including a composition of this invention through a matrix at a rate and pressure into a formation to control sand and fine production or migration into the production fluids.

The present invention also provide another method for controlling sand or fines migration including the step of depositing a coated particulate solid material of this invention adjacent screen-type sand and fines control devices so that the sand and/or fines are attracted to the coated particles and do not encounter or foul the screen of the screen-type device.

Embodiments of this invention provide compositions including: (1) aggregating compositions capable of forming deformable partial or complete coatings on formation surfaces, formation particle surfaces, downhole fluid solid surfaces, and/or proppant surfaces, where the coatings increase aggregation and/or agglomeration propensities of the particles and surfaces to form particles clusters or pillars having deformable coatings, and (2) aggregation stabilizing and/or strengthening compositions capable of altering properties of the coated clusters or pillars to form consolidated, stabilized, and/or strengthened clusters or pillars. The stabilized and/or strengthening proppant materials may be used in fracturing applications, frac pack applications, slick water applications, sand pack applications, formation consolidation application for consolidating unconsolidated or weakly consolidated formations, or any other application where proppant having a strengthened zeta potential altering coating (partial or complete) would be applicable. In all of these applications, the aggregating compositions and coating crosslinking compositions may be added to the treating fluids at any time during the treatments and alone or in combination. Generally, the coating crosslinking compositions will be used after the zeta potential altering compositions or after the injection of proppant treated with the zeta potential altering compositions. In some cases crosslinking compositions can be intimately mixed with the zeta particle altering composition so as to treat as one component system. This composition is tailored to give a delayed consolidation or crosslinking effect either triggered by heat or time.

### Definitions Used in the Invention

The term “substantially” means that the property is within 80% of its desired value. In other embodiments, “substantially” means that the property is within 90% of its desired value. In other embodiments, “substantially” means that the property is within 95% of its desired value. In other embodiments, “substantially” means that the property is within 99% of its desired value. For example, the term “substantially complete” as it relates to a coating, means that the coating is at least 80% complete. In other embodiments, the term “substantially complete” as it relates to a coating, means that the coating is at least 90% complete. In other embodiments, the term “substantially complete” as it relates to a coating, means that the coating is at least 95% complete. In other embodiments, the term “substantially complete” as it relates to a coating, means that the coating is at least 99% complete.

The term “substantially” means that a value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “about” means that the value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “drilling fluids” refers to any fluid that is used during well drilling operations including oil and/or gas wells, geo-thermal wells, water wells or other similar wells.

An over-balanced drilling fluid means a drilling fluid having a circulating hydrostatic density (pressure) that is greater than the formation density (pressure).

An under-balanced and/or managed pressure drilling fluid means a drilling fluid having a circulating hydrostatic density (pressure) lower or equal to a formation density (pressure). For example, if a known formation at 10,000 ft (True Vertical Depth—TVD) has a hydrostatic pressure of 5,000 psi or 9.6 lbm/gal, an under-balanced drilling fluid would have a hydrostatic pressure less than or equal to 9.6 lbm/gal. Most under-balanced and/or managed pressure drilling fluids include at least a density reduction additive. Other additives may be included such as corrosion inhibitors, pH modifiers and/or a shale inhibitors.

The term “proppant pillar, proppant island, proppant cluster, proppant aggregate, or proppant agglomerate” mean that a plurality of proppant particles are aggregated, clustered, agglomerated or otherwise adhered together to form discrete structures.

The term “mobile or re-healing proppant pillar, proppant island, proppant cluster, proppant aggregate, or proppant agglomerate” means proppant pillar, proppant island, proppant cluster, proppant aggregate, or proppant agglomerate that are capable of repositioning during fracturing, producing, or injecting operations.

The term “self healing proppant pillar, proppant island, proppant cluster, proppant aggregate, or proppant agglomerate” means proppant pillar, proppant island, proppant cluster, proppant aggregate, or proppant agglomerate that are capable of being broken apart and recombining during fracturing, producing, or injecting operations.

The term “amphoteric” refers to surfactants that have both positive and negative charges. The net charge of the surfactant can be positive, negative, or neutral, depending on the pH of the solution.

The term “anionic” refers to those viscoelastic surfactants that possess a net negative charge.

The term “fracturing” refers to the process and methods of breaking down a geological formation, i.e. the rock formation around a well bore, by pumping fluid at very high pressures, in order to increase production rates from a hydrocarbon reservoir. The fracturing methods of this invention use otherwise conventional techniques known in the art.

The term “proppant” refers to a granular substance suspended in the fracturing fluid during the fracturing operation, which serves to keep the formation from closing back down upon itself once the pressure is released. Proppants envisioned by the present invention include, but are not limited to, conventional proppants familiar to those skilled in the art such as sand, 20-40 mesh sand, resin-coated sand, sintered bauxite, glass beads, and similar materials.

The abbreviation “RPM” refers to relative permeability modifiers.

The term “surfactant” refers to a soluble, or partially soluble compound that reduces the surface tension of liquids, or reduces inter-facial tension between two liquids, or a liquid and a solid by congregating and orienting itself at these interfaces.

The term “viscoelastic” refers to those viscous fluids having elastic properties, i.e., the liquid at least partially returns to its original form when an applied stress is released.

The phrase “viscoelastic surfactants” or “VES” refers to that class of compounds which can form micelles (spherulitic, anisometric, lamellar, or liquid crystal) in the presence of counter ions in aqueous solutions, thereby imparting viscosity to the fluid. Anisometric micelles in particular are preferred, as their behavior in solution most closely resembles that of a polymer.

The abbreviation “VAS” refers to a Viscoelastic Anionic Surfactant, useful for fracturing operations and frac packing. As discussed herein, they have an anionic nature with preferred counterions of potassium, ammonium, sodium, calcium or magnesium.

The term “foamable” means a composition that when mixed with a gas forms a stable foam.

The term “fracturing layer” is used to designate a layer, or layers, of rock that are intended to be fractured in a single fracturing treatment. It is important to understand that a “fracturing layer” may include one or more than one of rock layers or strata as typically defined by differences in permeability, rock type, porosity, grain size, Young's modulus, fluid content, or any of many other parameters. That is, a “fracturing layer” is the rock layer or layers in contact with all the perforations through which fluid is forced into the rock in a given treatment. The operator may choose to fracture, at one time, a “fracturing layer” that includes water zones and hydrocarbon zones, and/or high permeability and low permeability zones (or even impermeable zones such as shale zones) etc. Thus a “fracturing layer” may contain multiple regions that are conventionally called individual layers, strata, zones, streaks, pay zones, etc., and we use such terms in their conventional manner to describe parts of a fracturing layer. Typically the fracturing layer contains a hydrocarbon reservoir, but the methods may also be used for fracturing water wells, storage wells, injection wells, etc. Note also that some embodiments of the invention are described in terms of conventional circular perforations (for example, as created with shaped charges), normally having perforation tunnels. However, the invention may also be practiced with other types of “perforations”, for example openings or slots cut into the tubing by jetting.

The term “MSFR” means maximum sand free production rate, which is the maximum production rate that can be achieved in a well without the co-production of sand or formation particulate.

The term “cavitation or cavitating” means to form cavities around production tubing, casing or cemented casing, i.e., to produce a volume free of sand surrounding the production tubing, casing or cemented casing.

The term “cavitated formation” is a formation having a cavity or cavities surrounding the production tubing, casing or cemented casing.

The term “draw down pressure” means a reduction in a pressure that is required to move the content, such as but not limited to, oil, gas and/or water, of the formation or zone into the casing, liner or tubing.

The term “critical draw down pressure” means the reduction in a pressure that is required to produce formation particulate, such as but not limited to, silica, clay, sand, and/or fines, into the casing or liner or tubing.

The term “aggregated, agglomerated or conglomerated formation” means that the weakly consolidated, semi-consolidated or unconsolidated formation has been treated with an aggregation, agglomeration, or conglomeration composition so that the formation is stable enough to produce below its critical draw down pressure without collapse.

The term relative “draw down pressure” means draw down pressure per unit area of the producible formation or zone.

The term “mole ratio” or “molar ratio” means a ratio based on relative moles of each material or compound in the ratio.

The term “weight ratio” means a ratio based on relative weight of each material or compound in the ratio.

The term “volume ratio” means a ratio based on relative volume of each material or compound in the ratio.

The term “g” means grams.

The term “mole %” means mole percent.

The term “vol. %” means volume percent.

The term “wt. %” means weight percent.

The term “SG” means specific gravity.

The term “gpt” means gallons per thousand gallons.

The term “ppt” means pounds per thousand gallons.

The term “ppg” means pounds per gallon.

### DETAILED DESCRIPTION OF THE INVENTION

The inventors have found that aggregating compositions can be produced that change, alter, and/or modify a zeta potential, an aggregating propensity, and/or an agglomerating propensity of surfaces of solid materials. The aggregating compositions include one reaction product or a plurality of reaction products of: (a) at least one nitrogen-containing compound, and (b) at least one amine reactive compound. The nitrogen-containing compounds include: (a) one amine or a plurality of amines, (b) one epoxy-modified amine or a plurality of epoxy-modified amines, (c) one oligomeric amine (oligoamine) or a plurality of oligomeric amines (oligoamines), (d) one epoxy-modified oligoamine or a plurality of epoxy-modified oligoamines, (e) one polymeric amine (polyamine) or a plurality of polymeric amines (polyamines), (f) one epoxy-modified polyamine or a plurality of epoxy-modified polyamines, (g) one amine containing polymer or a plurality of amine containing polymers, (h) one epoxy-modified amine containing polymer or a plurality of epoxy-modified amine containing polymers; (i) one reaction product of at least one epoxy containing compound and at least one nitrogen-containing compound or a plurality of reaction products of at least one epoxy containing compound and at least one nitrogen-containing compound; (j) one biopolymer or a plurality of biopolymers, (k) one epoxy-modified biopolymer or a plurality of epoxy-modified biopolymers, and (l) mixtures or combinations. The amine reactive compound include: (1) an acid containing compound that forms a negative charge upon deprotonation, such as, for example, acidic nitrogen containing compounds, or one acidic hydroxyl containing compound or a plurality of acidic hydroxyl containing compounds, (2) one homo and mixed anhydride of acidic hydroxyl containing compounds or a plurality of homo and mixed anhydride of acidic hydroxyl containing compounds; (3) one Lewis acid or a plurality of Lewis acids, (4) one phosphate-containing compound or a plurality of phosphate-containing compounds, or (5) mixtures and combinations thereof, where the phosphate-containing compounds is used in conjunction with one of the other amine reactive compounds. The solid materials may include particulate solid materials, solid materials, solid substrates, or mixtures and combinations thereof. The inventors have also found that treated solid materials may be prepared, where the solid materials include a complete or partial coating of at least one aggregating composition of this invention improving aggregation tendencies and/or aggregation propensities and/or alter particle zeta potentials. The inventors have also found that the aggregating compositions and/or the treated solid materials may be used in oil field applications including drilling, fracturing, completion, producing, injecting, sand control, or any other downhole application, where augmenting, changing, altering and/or modifying the zeta potentials, aggregating propensities, and/or an agglomerating propensities of solid materials both in the formation, fluids produced from the formation, or fluids injected into the formation. The inventors have also found that the treated solid materials or treated solid material particles can be used in any other application, where increased particle aggregation potentials are desirable or where decreased absolute values of the zeta potential of the particles, which is a measure of aggregation propensity. The inventors have also found that coated particulate solid materials can be formed, where the coating is deformable and the coated particles tend to self-aggregate and tend to cling to surfaces having similar coatings or having similar chemical and/or physical properties to that of the coated particulate solid materials. That is to say, that the coated particles tend to prefer like compositions, which increase their self-aggregation propensity and increase their ability to adhere to surface that have similar chemical and/or physical properties. The inventors have also found that the aggregating compositions of this invention are distinct from known compositions for modifying particle aggregation propensities and/or zeta potentials and that the coated particles are ideally suited as proppants, where the particles have altered zeta potentials that change properties of the particles causing them to attract similar materials and/or self-agglomerate or self-aggregate and/or adhere to surfaces having similar properties or treated with a similar aggregating composition. The change in zeta potential or aggregation propensity causes each particle to have an increased adhesion to the surfaces of the fractures increasing a frictional drag acting on the particles keeping the proppant in the fracture or causes the particles to form islands or pillars within the fractures within a formation, either naturally occurring or formed in a fracturing operation. The compositions are also ideally suited for decreasing fines migrating into a fracture pack or to decrease the adverse impact of fines migration into a fractured pack.

In the case of drilling, the compositions of this invention can be used to coat the formation and formation cuttings during drilling, because the particle tend to self aggregate and/or cling to similar modified formation surfaces. Again, an advantage of the self-aggregation is a reduced tendency of the cuttings to foul or plug screens. Additional advantages are to coat the formation walls with a composition of this invention during drilling to consolidate the formation and to consolidate or aggregate fines or particles in the drilling fluid to keep the rheological properties of the drilling fluid from changing and increasing equivalent circulating density (ECD).

### Compositions

The invention broadly relates to aggregating compositions including reaction products of at least one nitrogen-containing compound and at least one amine reactive compound and mixtures or combinations. The nitrogen-containing compounds include: (a) one amine or a plurality of amines, (b) one epoxy-modified amine or a plurality of epoxy-modified amines, (c) one oligomeric amine (oligoamine) or a plurality of oligomeric amines (oligoamines), (d) one epoxy-modified oligoamine or a plurality of epoxy-modified oligoamines, (e) one polymeric amine (polyamine) or a plurality of polymeric amines (polyamines), (f) one epoxy-modified polyamine or a plurality of epoxy-modified polyamines, (g) one amine containing polymer or a plurality of amine containing polymers, (h) one epoxy-modified amine containing polymer or a plurality of epoxy-modified amine containing polymers; (i) one reaction product of at least one epoxy containing compound and at least one nitrogen-containing compound or a plurality of reaction products of at least one epoxy containing compound and at least one nitrogen-containing compound; (j) one biopolymer or a plurality of biopolymers, (k) one epoxy-modified biopolymer or a plurality of epoxy-modified biopolymers, and (l) mixtures or combinations. The amine reactive compound include: (1) one acidic hydroxyl containing compound or a plurality of acidic hydroxyl containing compounds, (2) one homo and mixed anhydride of acidic hydroxyl containing compounds or a plurality of homo and mixed anhydride of acidic hydroxyl containing compounds; (3) one Lewis acid or a plurality of Lewis acids, (4) one phosphate-containing compound or a plurality of phosphate-containing compounds, or (5) mixtures and combinations thereof, where the phosphate-containing compounds is used in conjunction with one of the other amine reactive compounds. In certain embodiments, the compositions of this invention may also include reaction products of a phosphate containing compound in combination with the an acidic hydroxyl containing compound and/or a Lewis acid. In other embodiments, the compositions may also include: (a) reaction products of at least one acidic hydroxyl containing compound and at least one nitrogen-containing compound; (b) reaction products of at least one Lewis acid and at least one nitrogen-containing compound; (c) reaction products of at least one acidic hydroxyl containing compounds and at least one Lewis acid and at least one nitrogen-containing compound; (d) reaction products of at least one acidic hydroxyl containing compound and at least one phosphate containing compound and at least one nitrogen-containing compound; (e) reaction products of at least one Lewis acid and at least one phosphate containing compound and at least one nitrogen-containing compound; (f) reaction products of at least one acidic hydroxyl containing compound, at least one Lewis acid, and at least one phosphate containing compound and at least one nitrogen-containing compound; or (g) mixtures and combinations thereof; and (h) reaction product of at least one phosphate containing compounds and at least one nitrogen-containing compound. The aggregating composition of this invention augment, modify, change, and/or alter surfaces of solid materials or portions thereof augmenting, modifying, changing, and/or altering the chemical and/or physical properties of the surfaces. The augmented, modified, changed, and/or altered properties permit the surfaces to become self attracting or permit the surfaces to be attractive to materials having similar chemical and/or physical properties. In the case of particles including metal oxide particles such as particles of silica, alumina, titania, magnesia, zirconia, other metal oxides or oxides including a mixture of these metal oxides (natural or synthetic), the compositions form a complete or partial coating on the surfaces of the particles. The coating may interact with the surfaces by chemical and/or physical interactions including, without limitation, chemical bonds, hydrogen bonds, electrostatic interactions, dipolar interactions, hyperpolarizability interactions, cohesion, adhesion, adherence, mechanical adhesion or any other chemical and/or physical interaction that allows a coating to form on the particles. The coated particles have a greater aggregation or agglomeration propensity than the uncoated particles. Thus, the particles before treatment may be free flowing, while after coating are not free flowing, but tend to clump, aggregate or agglomerate. In cases, where the composition is used to coat surfaces of a geological formation, a synthetic metal oxide structure and/or metal-oxide containing particles, the particles will not only tend to aggregate together, the particles also will tend to cling to the coated formation or coated structural surfaces.

### Treated Structures and Substrates

The present invention also broadly relates to structures and substrates treated with a composition of this invention, where the structures and substrates include surfaces that are partially or completely coated with a composition of this invention. The structures or substrates can be ceramic or metallic or fibrous. The structures or substrates can be spun such as a glass wool or steel wool or can be honeycombed like catalytic converters or the like that include channels that force fluid to flow through tortured paths so that particles in the fluid are forced in contact with the substrate or structured surfaces. Such structures or substrates are ideally suited as particulate filters or sand control media.

### Methods for Treating Particulate Solids

The present invention broadly relates to a method for treating metal oxide-containing surfaces including the step of contacting the solid material such as metal oxide-containing materials with a composition of this invention. The composition forms a partial or complete coating on the surfaces of the materials modifying, changing and/or altering the properties of the surfaces so that the surfaces are now capable to interacting with similarly treated surfaces to form agglomerated and/or aggregated structures. The treating may be designed to coat continuous surfaces and/or the surfaces of solid particles. If both are treated, then the particles cannot only self-aggregate, but the particles may also aggregate, agglomerate and/or cling to the coated continuous surfaces. The compositions may be used in fracturing fluids, in drilling fluids, in completion fluids, in production fluids, in sand or gravel control applications or any other downhole application. Additionally, the coated particles of this invention may be used in fracturing fluids. Moreover, structures, screens or filters coated with the compositions of this invention can be used to attract and remove fines that have been modified with the compositions of this invention. Furthermore, in certain applications, components of the aggregating compositions may be used in unreacted form, provided that the downhole conditions are sufficient for the components to react to form the aggregating compositions of this invention and to form a partial or complete coating on particles or surfaces downhole.

Method for Fracturing and/or Propping

The present invention broadly relates to methods for fracturing a formation including the step of pumping a fracturing fluid including a composition of this invention into a producing formation at a pressure sufficient to fracture the formation. The composition modifies an aggregation potential and/or zeta-potential of formation particles and formation surfaces during fracturing so that the formation particles aggregate and/or cling to the formation surfaces or each other increasing fracturing efficiency and increasing productivity of the fracture formation. The composition of this invention can also be used in a pre-pad step to modify the surfaces of the formation so that during fracturing the formation surfaces are pre-coated. The prepared step involves pumping a fluid into the formation ahead of the treatment to initiate the fracture and to expose the formation face with fluids designed to protect the formation. Beside just using the composition as part of the fracturing fluid, the fracturing fluid can also include particles that have been prior treated with the composition of this invention, where the treated particles act as proppants to prop open the formation after fracturing. If the fracturing fluid also includes the composition, then the coated particle proppant will adhere to formation surfaces to a greater degree than would uncoated particle proppant.

In an alternate embodiment of this invention, the fracturing fluid includes particles coated with a composition of this invention as proppant. In this embodiment, the particles have a greater self-aggregation propensity and will tend to aggregate in locations that may most need to be propped open. In all fracturing applications including proppants coated with or that become coated with the composition of this invention during fracturing, the coated proppants are likely to have improved formation penetration and adherence properties. These greater penetration and adherence or adhesion properties are due not only to a difference in the surface chemistry of the particles relative to the surface chemistry of un-treated particles, but also due to a deformability of the coating itself. Thus, the inventors believe that as the particles are being forced into the formation, the coating will deform to allow the particles to penetrate into a position and as the pressure is removed the particles will tend to remain in place due to the coating interaction with the surface and due to the relaxation of the deformed coating. In addition, the inventors believe that the altered aggregation propensity of the particles will increase proppant particle density in regions of the formation most susceptible to proppant penetration resulting in an enhance degree of formation propping.

### Method for Drilling

The present invention also broadly relates to a method for drilling including the step of, while drilling, circulating a drilling fluid to provide bit lubrication, heat removal and cutting removal, where the drill fluid includes a composition of this invention, which increases an aggregation potential or decrease an absolute value of the zeta potential of any particulate solids in the drilling fluid or that becomes entrained in the drilling fluid to increase solids removal.

The present invention also broadly relates to a method for drilling including the step of while drilling, circulating a first drilling fluid to provide bit lubrication, heat removal and cutting removal. Upon encountering an underground structure that produces undesirable quantities of particulate solids including metal oxide-containing solids, changing the first drilling fluid for a second drilling fluid including a composition of this invention to provide bit lubrication, heat removal and cutting removal and to increase an aggregation potential or decrease an absolute value of the zeta potential of any solid including particulate metal oxide-containing solids in the drilling fluid or that becomes entrained in the drilling fluid to increase solids removal.

The present invention also broadly relates to a method for drilling including the step of, while drilling, circulating a first drilling fluid to provide bit lubrication, heat removal and cutting removal. Upon encountering an underground structure that produces undesirable quantities of particulate solids including metal oxide-containing solids, changing the first drilling fluid for a second drilling fluid including a composition of this invention to provide bit lubrication, heat removal and cutting removal and to increase an aggregation potential or zeta potential of any particulate solid including metal oxide-containing solid in the drilling fluid or that becomes entrained in the drilling fluid to increase solids removal. After passing through the structure that produces an undesired quantities of particulate metal oxide-containing solids, change the second drilling fluid for the first drilling fluid or a third drilling fluid.

### Method for Producing

The present invention also broadly relates to a method for producing including the step of circulating and/or pumping a fluid into, where the fluid includes a composition of this invention, which increases an aggregation potential or decreases an absolute value of the zeta potential of any particulate solid including a metal oxide-containing solid in the fluid or that becomes entrained in the fluid to increase solids removal and to decrease the potential of the particles plugging the formation and/or production tubing.

### Suitable Materials for Use in the Invention

### Amines

Suitable amines include, without limitation, any amine that is capable of reacting with an acidic hydroxyl containing compound, a Lewis acid, or mixtures and combinations and with phosphate containing compounds, if present, to form a deformable coating on a metal-oxide-containing surface. Exemplary examples of such amines include, without limitation, any amine of the general formula R¹R²NH, R¹R²R³N, or mixtures or combinations thereof, oligomeric and/or polymeric derivatives thereof, or mixtures or combinations thereof, where R¹, R² and R³ are independently a hydrogen atom or a hydrocarbyl group having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof. Exemplary examples of amines suitable for use in this invention include, without limitation, aniline and alkyl anilines or mixtures of alkyl anilines, pyridines and alkyl pyridines or mixtures of alkyl pyridines, pyrrole and alkyl pyrroles or mixtures of alkyl pyrroles, piperidine and alkyl piperidines or mixtures of alkyl piperidines, pyrrolidine and alkyl pyrrolidines or mixtures of alkyl pyrrolidines, indole and alkyl indoles or mixture of alkyl indoles, imidazole and alkyl imidazole or mixtures of alkyl imidazole, quinoline and alkyl quinoline or mixture of alkyl quinoline, isoquinoline and alkyl isoquinoline or mixture of alkyl isoquinoline, pyrazine and alkyl pyrazine or mixture of alkyl pyrazine, quinoxaline and alkyl quinoxaline or mixture of alkyl quinoxaline, acridine and alkyl acridine or mixture of alkyl acridine, pyrimidine and alkyl pyrimidine or mixture of alkyl pyrimidine, quinazoline and alkyl quinazoline or mixture of alkyl quinazoline, or mixtures or combinations thereof.

Suitable amines capable of forming a deformable coating on a solid particles, surfaces, and/or materials include, without limitation, heterocyclic aromatic amines, substituted heterocyclic aromatic amines, or mixtures or combinations thereof, where the substituents of the substituted heterocyclic aromatic amines are hydrocarbyl groups having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof. In certain embodiments, amines suitable for use in this invention include, without limitation, aniline and alkyl anilines or mixtures of alkyl anilines, pyridines and alkyl pyridines or mixtures of alkyl pyridines, pyrrole and alkyl pyrroles or mixtures of alkyl pyrroles, piperidine and alkyl piperidines or mixtures of alkyl piperidines, pyrrolidine and alkyl pyrrolidines or mixtures of alkyl pyrrolidines, indole and alkyl indoles or mixture of alkyl indoles, imidazole and alkyl imidazole or mixtures of alkyl imidazole, quinoline and alkyl quinoline or mixture of alkyl quinoline, isoquinoline and alkyl isoquinoline or mixture of alkyl isoquinoline, pyrazine and alkyl pyrazine or mixture of alkyl pyrazine, quinoxaline and alkyl quinoxaline or mixture of alkyl quinoxaline, acridine and alkyl acridine or mixture of alkyl acridine, pyrimidine and alkyl pyrimidine or mixture of alkyl pyrimidine, quinazoline and alkyl quinazoline or mixture of alkyl quinazoline, or mixtures or combinations thereof.

### Polyamines

Suitable amines include, without limitation, any polyamine that is capable of reacting with an acidic hydroxyl containing compound, a Lewis acid, or mixtures and combinations and with phosphate containing compounds, if present, to form deformable coating on solid surfaces. Exemplary examples of such polyamines include, without limitation, any compound including two or more amino groups of the general formula —NR¹R², where R¹ and R² are independently a hydrogen atom or a hydrocarbyl group having between about 1 and 20 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof.

### Polymeric Amines

Suitable polymers for use in the compositions of this invention that are capable of reacting with amine reactive compound such as an acidic hydroxyl containing compound, a Lewis acid, or mixtures and combinations and with phosphate containing compounds, if present, to form deformable coating on solid materials include, without limitation, any polymer including repeat units including an amino group or a nitrogen containing heterocyclic group or mixtures thereof. Exemplary examples are polymers that include one or a plurality of amino groups of the general formula NR′R² as set forth above, where compounds include, without limitation, pyrrole, substituted pyrrole, pyridines, substituted pyridines, quinolines, substituted quinolines, anilines, substituted anilines, piperidines, substituted piperidines, pyrrolidines, substituted pyrrolidines, imidazoles, substituted imidazoles, pyrazines, substituted pyrazines, pyrimidines, substituted pyrimidines, quinazolines, substituted quinazolines, or mixtures or combinations thereof. Exemplary examples of repeat units include, without limitation, heterocyclic aromatic vinyl monomer, where the hetero atoms is a nitrogen atom or a combination of a nitrogen atom and another hetero atoms selected from the group consisting of boron, oxygen, phosphorus, sulfur, germanium, or mixtures and combinations thereof. The polymers may be homopolymers of cyclic or aromatic nitrogen-containing vinyl monomers, or copolymers of any ethylenically unsaturated monomers that will copolymerize with a cyclic or aromatic nitrogen-containing vinyl monomer. Exemplary cyclic or aromatic nitrogen-containing vinyl monomers include, without limitation, vinyl pyrroles, substituted vinyl pyrroles, vinyl pyridines, substituted vinyl pyridines, vinyl quinolines or substituted vinyl quinolines, vinyl anilines or substituted vinyl anilines, vinyl piperidines or substituted vinyl piperidines, vinyl pyrrolidines or substituted vinyl pyrrolidines, vinyl imidazole or substituted vinyl imidazole, vinyl pyrazine or substituted vinyl pyrazines, vinyl pyrimidine or substituted vinyl pyrimidine, vinyl quinazoline or substituted vinyl quinazoline, or mixtures or combinations thereof. Exemplary pyridine monomer include 2-vinyl pyridine, 4-vinyl pyridine, or mixtures or combinations thereof. Exemplary homopolymers include poly-2-vinyl pyridine, poly-4-vinyl pyridine, and mixtures or combinations thereof. Exemplary copolymers including copolymers or 2-vinyl pyridine and 4-vinyl pyridine, copolymers of ethylene and 2-vinyl pyridine and/or 4-vinyl pyridine, copolymers of 4-vinylpyridine and 4-vinylpyridine N-oxide, copolymers of 4-vinylpyridine and styrene, copolymers of 4-vinylpyridnes and N,N-dimethylaminopropyl methacrylate, copolymers of styrene and N,N-dimethylaminopropyl methacrylate, polymers of propylene and 2-vinyl pyridine and/or 4-vinyl pyridine, copolymers of acrylic acid and 2-vinyl pyridine and/or 4-vinyl pyridine, copolymers of methacrylic acid and 2-vinyl pyridine and/or 4-vinyl pyridine, copolymers of acrylates and 2-vinyl pyridine and/or 4-vinyl pyridine, copolymers of methacrylates and 2-vinyl pyridine and/or 4-vinyl pyridine, and mixtures of combinations thereof. All of these monomers can also include substituents. Moreover, in all these vinyl monomers or ethylenically unsaturated monomers, one or more of the carbon atoms can be replaced by one or more hetero atoms selected from the group consisting of boron, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof. Of course, all of these monomers includes at least one nitrogen atom in the structure and/or Lewis acid. Other polymers include, without limitation, any polymer including repeat units derived from a heterocyclic or heterocyclic aromatic vinyl monomer, where the hetero atoms is a nitrogen atom or a combination of a nitrogen atom and another hetero atoms selected from the group consisting of boron, oxygen, phosphorus, sulfur, germanium, and/or mixtures thereof. The polymers may be homopolymers of cyclic or aromatic nitrogen-containing vinyl monomers, or copolymers of any ethylenically unsaturated monomers that will copolymerize with a cyclic or aromatic nitrogen-containing vinyl monomer. Exemplary cyclic or aromatic nitrogen-containing vinyl monomers include, without limitation, vinyl pyrroles, substituted vinyl pyrroles, vinyl pyridines, substituted vinyl pyridines, vinyl quinolines or substituted vinyl quinolines, vinyl anilines or substituted vinyl anilines, vinyl piperidines or substituted vinyl piperidines, vinyl pyrrolidines or substituted vinyl pyrrolidines, vinyl imidazole or substituted vinyl imidazole, vinyl pyrazine or substituted vinyl pyrazines, vinyl pyrimidine or substituted vinyl pyrimidine, vinyl quinazoline or substituted vinyl quinazoline, or mixtures or combinations thereof. Examples of co-monomers for vinyl polymers: styrene, acrylamides, acrylates, methacrylate, etc.

The oligomers and/or polymers of this invention generally have a weight average molecular weight of between about 500 and 1,000,000. In other embodiments, the weight average molecular weight is of between about 500 and 500,000. In other embodiments, the weight average molecular weight is between about 500 and 100,000. In other embodiments, the weight average molecular weight is between about 500 and 50,000. In other embodiments, the weight average molecular weight is between about 500 and 20,000. In other embodiments, the weight average molecular weight is between about 500 and 5,000. In all case, the weight average molecular weights and nature of the monomer make up of the oligomers and/or polymers of this invention are tailored to specific surfaces that compositions is to treat.

Biooligomers and/or Biopolymers

Suitable biooligomers and biopolymers include, without limitation, chitosans, polypeptides including at least one amino acid selected from the group consisting of lysine, tryptophan, histidine, arginine, asparagine, glutamine, and mixtures or combinations thereof, protein containing gelatins, and mixtures or combinations thereof.

### Phosphate Containing Compounds

Suitable phosphate containing compounds include, without limitation, any phosphoric acid, polyphosphoric acid, other phosphorus acids, methylene phosphonic acids, and phosphate ester that are capable of reacting with a suitable amine to form a composition that forms a deformable coating on a metal-oxide containing surface or partially or completely coats particulate materials. Exemplary examples of such phosphate esters include, without limitation, any phosphate esters of the general formula P(O)(OR⁴)(OR⁵)(OR⁶) or mixture or combinations thereof, oligomeric and/or polymeric derivatives thereof, where R⁴, R⁵, and R⁶ groups are independently a hydrogen atom or a hydrocarbyl group having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof. Exemplary examples of phosphate esters include, without limitation, phosphate ester of alkanols having the general formula P(O)(OH)ₓ(OR⁷)_{y}, oligomeric and/or polymeric derivatives thereof, where x+y=3 and R⁷ groups are independently a hydrogen atom or a hydrocarbyl group having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof such as ethoxy phosphate, propoxyl phosphate or higher alkoxy phosphates or mixtures or combinations thereof. Other exemplary examples of phosphate esters include, without limitation, phosphate esters of alkanol amines having the general formula N[R⁸OP(O)(OH)₂]₃, oligomeric and/or polymeric derivatives thereof, where R⁸ are independently linking groups sometime referred to as hydrocarbenyl groups (meaning that the groups are bonded to two different groups such as methylene CH2, ethylene CH2CH2, etc.) having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof group including the tri-phosphate ester of tri-ethanol amine or mixtures or combinations thereof. Other exemplary examples of phosphate esters include, without limitation, phosphoric acid, polyphosphoric acid, phosphate esters of hydroxylated aromatics such as phosphate esters of alkylated phenols such as nonylphenyl phosphate ester, phenolic phosphate esters or nonylphenol ethoxylate phosphate esters. Other exemplary examples of phosphate esters include, without limitation, phosphate esters of triethanolamine, oleyl alcohol, 2-ethylhexanol, phosphate esters of diols and polyols such as phosphate esters of ethylene glycol, propylene glycol, or higher glycolic structures, phosphate esters of ethoxylated alcohols such as ethoxylated decyl alcohol, phosphoric acid of decyl octyl ester, poly(oxy-1,2-ethanediyl),alpha-tridecyl-omega-hydroxy-phosphate and the like. Phosphate esters of ethoxylated decyl alcohol is sold as Phosphated DA-4 and DA-6 by Manufacturers Chemicals, LLC. Phosphoric acid of decyl octyl ester is sold as Crodafos 810A-LQ-(RB) by Croda Europe Limited. Poly(oxy-1,2-ethanediyl),alpha-tridecyl-omega-hydroxy-phosphates sold as Crodafos T5A-LQ-(RB) by Croda Europe Limited. Other exemplary phosphate esters include any phosphate ester than can react with an amine and coated on to a substrate forms a deformable coating enhancing the aggregating potential of the substrate.

In addition, the monomeric or oligomeric phosphate ester may be extended to include any polymer containing phosphate groups including organic and inorganic polyphosphates including cyclic and linear phosphates. Importantly, amine-based formulations are generally more effective on metal oxide materials such as sand (silicon dioxide) with a negative or partially negative charge compared to on calcium carbonate (limestone) or other positively or partially positively charged materials. In certain embodiments, polymeric phosphates without an amine component may be used to effectively bind and agglomerate positively charged materials. Some amine may also be present (to bring down water solubility for instance), but the phosphate groups would have to be in excess so the molecules have a net negative charge to bind to positively charged surfaces. Also, we believe that N-oxides groups may be used to agglomerate any type of surface, because they have a polar rather than a true charged nature that could be attracted to either positively or negatively charged surfaces.

Exemplary examples of such methylene phosphonic acids include, without limitation, any methylene phosphonic acids of the general formula:

R⁹R¹⁰N—CH₂—P(O)(OH)₂

or mixture or combinations thereof, oligomeric and/or polymeric derivatives thereof, where the R⁹ and R¹⁰ groups are independently a hydrogen atom or a hydrocarbyl group having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof. Suitable methylene phosphonic acids capable of reacting with amines to form deformable coating on solid materials include, without limitation, are aminoethyl ethanol amine tris(methylene phosphonic acid); diethylene triamine penta (methylene phosphonic acid); bis(hexmethylenetriamino penta(methylenephosphonic acid) and the like.

### Epoxy Compounds

Suitable epoxy compound for reacting with amines to form epoxy modified amines, epoxy modified amine oligomers, and/or epoxy modified amine polymers include without limitation, any epoxy compound that is capable of reacting with primary, secondary, heterocyclic amines, and/or tertiary amines. Exemplary examples include epoxy compound of the general formulas:

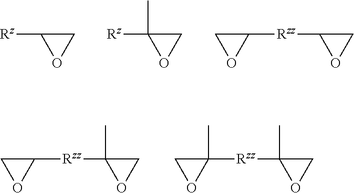

where R^{z} is a hydrocarbyl group having between about 1 and about 20 carbon atoms, where one or more of the carbon atoms may be replaced by oxygen atoms and where Rzz is a linking group selected from the group consisting of linear, branched, and/or cyclic hydrocarbyl linking groups, aromatic linking groups, alkaryl linking groups, araalkyl linking groups having from 1 to 40 carbon atom, where one or more of the carbon atoms may be replaced by oxygen atoms or mixtures and combinations thereof. Exemplary examples of epoxy compounds having two epoxy group include, without limitation, epoxy compounds of the following formulas:

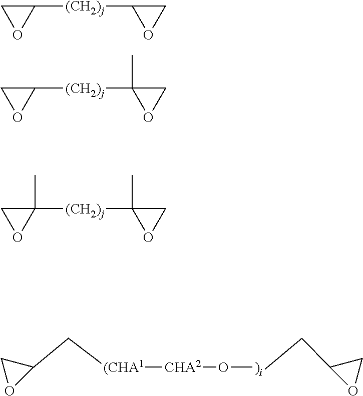

where j is an integer having a value between 1 and about 20 carbon atoms, where one or more carbon atoms are oxygen atoms and i is integer having a value between about 1 and about 20 carbon atoms, where one or more carbon atoms may be replaced by oxygen atoms or mixtures and combinations thereof. Exemplary example of specific epoxy compounds having two epoxy group include, without limitation, epoxy compounds of the following formulas:

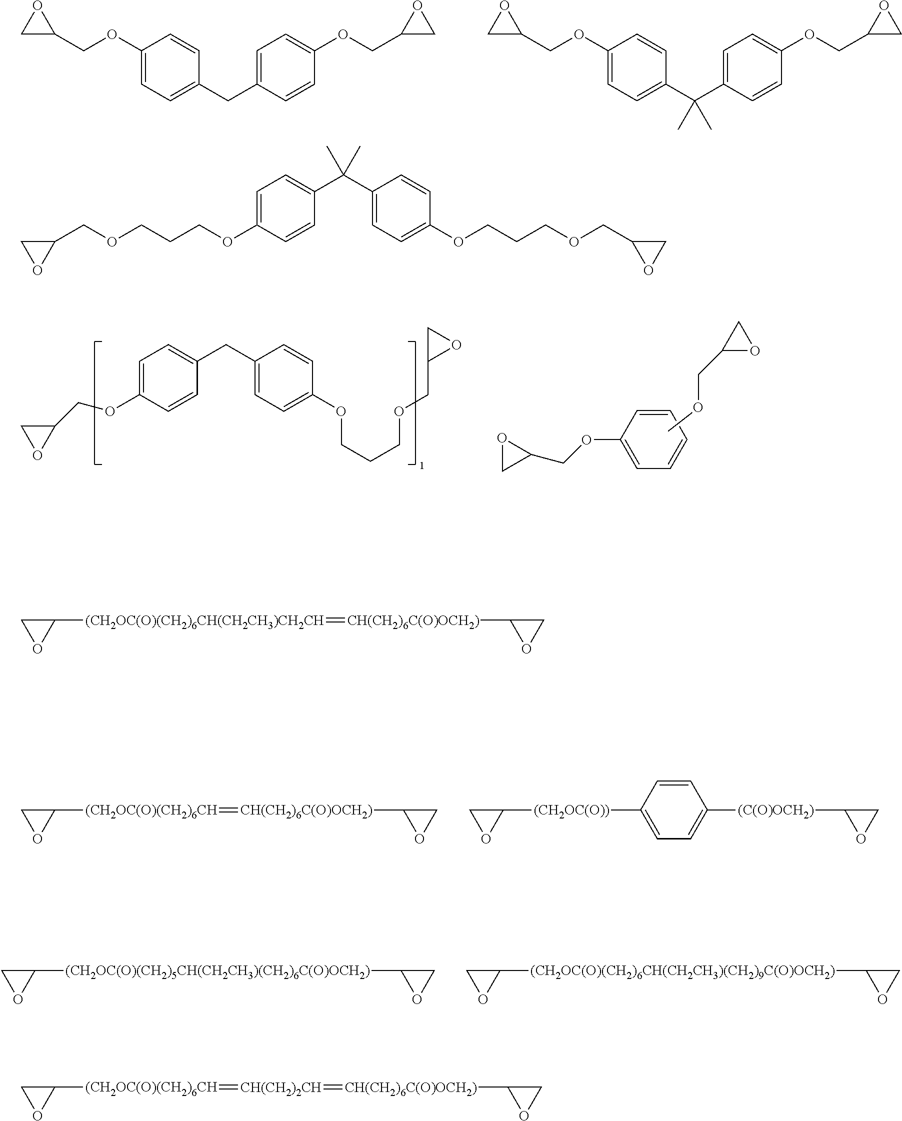

or mixtures and combinations thereof, where 1 is an integer having a value between 1 and about 100. Exemplary example of specific epoxy compounds having a plurality of epoxy groups include, without limitation, epoxy compounds of the following formulas:

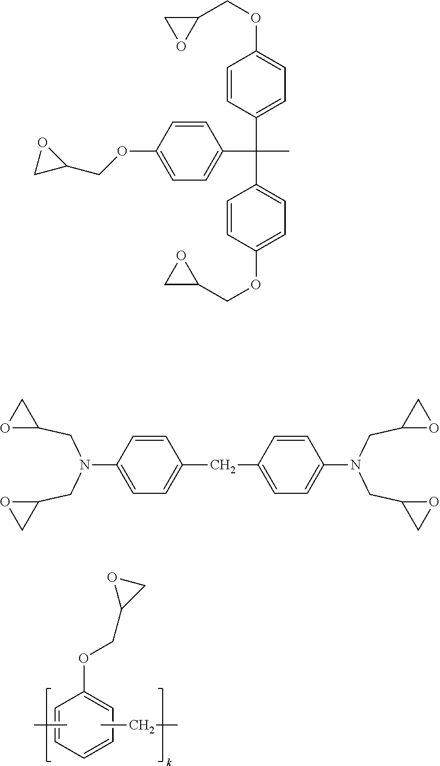

or mixtures and combinations thereof, where k is an integer having a value between about 10 to about 100,000 and where the polymeric epoxy compound may include non epoxy containing repeat units.

Suitable silane epoxy compounds may also be used. These compounds react with alkylpyridines, polyvinylpyridines, and tertiary amines to modify these amines. Silane epoxy compounds including alkoxy groups react with amines via the epoxy group and then the alkoxy group of the silane hydrolyze to form silanol groups (SiOH). The silanol groups are then available to bond with silanol group of solid materials such as silica (SiO₂) or sand. Exemplary examples of silane epoxy compounds include, without limitation, 3-glycidoxypropyltrimethoxysilane and 3-glycidoxypropyl triethoxy silane manufactured by Wacker Chemie AG in Munchen, German; and 3-glycidoxypropyl methyldimethoxysilane, 3-glycidoxypropyl methyl diethoxysilane and 3-glycidoxypropyl triethoxysilane manufactured by Shin-Etsu in Tokyo, Japan, other silane epoxy compound, or mixtures and combinations thereof.

Mono epoxy compounds, diepoxy compounds and blends can be reacted with aromatic heterocylic amine nitrogen to form conjugated 3,4-diene and cylic amide or pyridone structure. The conjugated 3,5-diene may then be further reacted with a phosphate compound, acidic hydroxyl group, anhydride or Lewis acid. Also, some of the aromatic heterocyclic amine nitrogens may be partially reacted with the epoxy compound and then the remaining aromatic heterocyclic amine nitrogens can be reacted with a phosphate compound, acidic hydroxyl containing compound, anhydride or Lewis acid. Suitable epoxy compounds capable of reacting with the aromatic heterocyclic amine nitrogens to form a deformable coating on solid materials include, C8-C10 glycidyl ether (Erisys GE-7); C12-C14 glycidyl ether (Erisys GE-7); butyl glycidyl ether; diglycidyl ether of bisphenol A; DER 330 epoxy resin, other similar compounds, and mixtures or combinations thereof.

### Acidic Hydroxyl Compounds

Suitable acidic hydroxyl compounds capable of reacting with amines to form deformable coating on solid materials include, without limitation, a mineral acid, an organic acid, or mixtures and combinations thereof. Exemplary examples of minerals acids include phosphoric acid, sulfur acid, hydrochloric acid, hydrobromic acid, nitric acid, boric acid, or mixtures and combinations thereof. Exemplary organic acids include, without limitation, monocarboxylic acids, dicarboxylic acids, polymeric carboxylic acids, and mixtures or combinations thereof, where the carboxylic acids include from about 1 to about 40 carbon atoms. Exemplary examples of monocarboxylic acids or anhydrides include formic acid, acetic acid, lactic acid, citric acid, succinic acid, maleic acid, adipic acid, tricarballylic acid, Westvaco Diacid 1550, Westvaco Tenax 2010, mellitic acid, and homo or mixed anhydrides thereof, or mixtures and combinations thereof. Exemplary Lewis acids are zinc chloride, titanium (IV) chloride, tin (IV) chloride, aluminum bromide, aluminum chloride, boron trichloride and boron trifluoride. In certain embodiments, the oligomeric amines and/or polymeric amines may be reacted with a combination of phosphate compounds and non-phosphate compounds as the reaction products may include phosphate compound-oligomeric amines and/or polymeric amines reactions products and non-phosphate compound-oligomeric amines and/or polymeric amines reaction products.

### Lewis Acid Compounds

Suitable Lewis acid compounds capable of reacting with amines to form deformable coating on solid materials include, without limitation, includes, without limitation, metal compounds capable of reaction with the amines, polyamines, polymeric amines, or mixtures and combinations thereof to form a deformable coating on solid materials. The metal compounds are selected from the group consisting of groups 2-17 metal compounds. The group 2 metal compounds include compounds of Be, Mg, Ca, Sr, and Ba. The group 3 metal compounds include compounds of Sc, Y, La and Ac. The group 4 metal compounds include compounds of Ti, Zr, Hf, Ce, and Th. The group 5 metal compounds include compounds of V, Nb, Ta, and Pr. The group 6 metal compounds include compounds of Cr, Mo, W, Nd, and U. The group 7 metal compounds include compounds of Mn, Tc, Re, and Pm. The group 8 metal compounds include compounds of Fe, Ru, Os, and Sm. The group 9 metal compounds include compounds of Co, Rh, Ir, and Eu. The group 10 metal compounds include compounds of Ni, Pd, Pt, and Gd. The group 11 metal compounds include compounds of Cu, Ag, Au, and Tb. The group 12 metal compounds include compounds of Zn, Cd, Hg, and Dy. The group 13 metal compounds include compounds of Al, Ga, In, Tl, and Ho. The group 14 metal compounds include compounds of Si, Ge, Sn, Pb, and Er. The group 15 metal compounds include compounds of As, Sb, Bi, and Tm. The group 16 metal compounds include compounds of Yb. The group 17 metal compounds include compounds of Lu. Alternatively, the metal compounds includes alkaline earth metal compounds, poor metal compounds, transition metal compounds, lanthanide metal compounds, actinide metal compounds, and mixtures or combinations thereof. The metal compounds may be in the form of halides, oxyhalides, tetrahaloboranes (e.g., BF 4), carbonates, oxides, sulfates, hydrogensulfates, sulfites, hydrosulfites, hexahalophosphates, phosphates, hydrogenphosphates, phosphites, hydrogenphosphites, nitrates, nitrites, carboxylates (e.g., formates, acetates, propionates, butionates, citrates, oxylates, or higher carboxylates), hydroxides, any other counterion, and mixtures or combinations thereof.

### Crosslinking Agents

Suitable organic crosslinking agents include, without limitation, poly-glycidyl ethers, such as, for example, di-glycidyl ethers and tri-glycidyl ethers or other higher poly-glycidyl ethers; hydrocarbyldihalides; bisphenol A; polyisocyanates, such as, for example, di-isocyanates and tri-isocyanates or other higher polyisocyanates; diacyl azides; cyanuaric chloride; diacids; polyacids; imidylated di and poly carboxylic acids; anhydrides; carbonates; polyepoxides, such as, for example, diepoxides or other higher polyepoxides; polyaldehydes, such as, for example, dialdehydes or other higher polyaldehydes; polyisothioisocyanates, such as, for example, diisothiocyanates or other higher polyisothioisocyanates; polyvinylsulfones, such as, for example, divinylsulfones or other higher polyvinylsulfones; silanes; and other similar organic crosslinking agents, or mixtures or combinations thereof.

Suitable silane crosslinking compounds, especially alkoxy silane compounds, may be used to crosslink compounds including hydroxyl groups, especially hydroxyl groups resulting from the reaction product of amines with amine reactive compounds such as organic acids, anhydrides, phosphate esters, or methylene phosphonic acid generating silanol groups that are available to react with silanol group on solid materials. Thus, these silane compound not only crosslink the aggregating compositions of this invention, but may also assist in anchoring the aggregating compositions of this invention to solid materials. Exemplary examples of silane crosslinking compound include, without limitation, triacetoxyethylsilane, 1,2-bis(triethyoxysilyl)ethan, 3-methacryloxy propyl trimethoxy silane, methacryloxy methyl trimethoxysilane, 3-isocyanato propyl trimethoxy silane, glycidoxy propyl triethoxy silane manufactured by Wacker Chemie AG in Munchen, German; p-styryl trimethoxy silane, vinyl trimethoxy silane, bis(triethoxysilylpropyl)tetrasulfide, KBE-9007, KBM-9659 and X-12-967C manufactured by Shin-Etsu in Tokyo, Japan, other silanes, or mixtures and combinations thereof. The crosslinking agents could be used to increase the agglomeration strength of the composition, or lead to consolidation/development of compressive strength.

### Resins

The compositions disclosed herein can also include resins. Resins suitable for use in the compositions and methods hereing can include all resins known in the art that are capable of forming a hardened, consolidated mass. Many suitable resins are commonly used in subterranean consolidation operations, and some suitable resins include two component epoxy based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, cyanate esters, polyurethane resins and hybrids and copolymers thereof, acrylate resins, and mixtures thereof.

Some suitable resins, such as epoxy resins, may be cured with an internal catalyst or activator so that when pumped down hole, they may be cured using only time and temperature. Other suitable resins, such as furan resins generally require a time-delayed catalyst or an external catalyst to help activate the polymerization of the resins if the cure temperature is low (i.e., less than 250° F.), but will cure under the effect of time and temperature if the formation temperature is above about 250° F., preferably above about 300° F. An epoxy resin may be preferred when using the methods of the present invention in formations having temperatures ranging from about 65° F. to about 350° F. and a furan resin may be preferred when using the methods of the present invention in formations having temperatures above about 300° F.

It is within the ability of one skilled in the art, with the benefit of this disclosure, to select a suitable resin for use in embodiments of the compositions and methods herein, and to determine whether a catalyst is required to trigger curing. As with the crosslinking agents, the resins and resin/catalyst blends could be used to increase the agglomeration strength of the composition, or lead to consolidation/development of compressive strength.

### Hydrophobic Agents

Hydrophobic agents can be reacted with the amine or polyamine to form deformable coating on solid materials. Suitable hydrophobic agents are organic halides such a 1-bromohexadecane, 1-chlorohexadecane, 1-bromotetradecane, 1-bromododecane, 1-bromooctane and the like.

### Tackifying Compounds

Tackifying compounds can be blended or reacted prior or subsequently with the aggregating agents of this invention. Suitable tackifying compounds and process are disclosed in U.S. Pat. Nos. 5,853,048; 7,258,170 B2 and US 2005/0277554 A1. Tackifying compositions or bonding agents include polyacrylate ester polymers, polyamide, phenolic and epoxy. Tackifying compounds may be produced by the reaction of a polyacid with a multivalent ion such as calcium, aluminum, iron or the like. Similarly various polyorganophosphates, polyphosphonate, polysulfate, polycarboxylates or polysilicates may be reacted with a multivalent ion to yield a tackifying compound. In certain embodiment, the tackifying agent is the condensation reaction of polyacids and polyamines. C36 dibasic acids, trimer acids, synthetic acids produced from fatty acids, maleic anhydride and acrylic acids are examples of polyacids. Polyamines can comprise ethylenediamine, diethylentriamine, triethylenetetramine, tetraethylenepentamine, N-(2-aminoethyl)piperazine and the like.

### Glymes

Suitable glymes including, without limitation, diethylene glycol dimethyl ether, ethylene-propylene glycol dimethyl ether, dipropylene glycol dimethyl ether, diethylene glycol diethyl ether, propylene glycol diethyl ether, dipropylene glycol diethyl ether, glycol ether EB (2-butoxyethnol), dipropylene glycol methyl ether or mixture or combinations thereof. In certain embodiments, the glyme is dipropylene glycol dimethyl ether sold as Proglyme from Novolyte Technologies of Independence, Ohio. Dipropylene glycol methyl ether is sold as Dowanol DPM by Dow Chemical Company.

### Ethoxylated Alcohols

Suitable ethoxylated alcohols are ethoxylated isotridecanol and a-hexyl-w-hydroxy poly(oxy-1,2-ethanediyl). Ethoxylated isotridecanol is sold as Novel TDA-3, TDA-4 or TDA-6 Ethoxylates by SASOL, a-Hexyl-w-hydroxy poly(oxy-1,2-ethanediyl) is sold as Novel 6-3 Ethoxylate by SASOL.

### Esters

Suitable esters include, without limitation, esters of monocarboxylic acids of formula R^{a}COOR^{b}, esters of dicarboxylic acids of formula R^{c}OOC—R^{aa}—COOR^{c}, esters of polycarboxylic acid of the formula R^{bb}(COOR^{d})ₙ, and mixtures or combinations thereof. In the formulas, R^{a}, R^{b}, R^{c}, and R^{d} are the same or different hydrocarbyl groups (linear, branched, saturated, unsaturated, aryl, alkaaryl, arylalkyl, or mixtures and combination thereof) having a single linking bond and having between 1 and 20 carbon atoms, R^{aa} and R^{bb} are linking hydrocarbyl groups including two or more linking bonds and having between 3 and 20 carbon atoms, and where n is an integer having a value between 3 and 1,000. In all of the hydrocabyl groups, one or more of the carbon atoms may be replaced by oxygen atoms. Exemplary examples of ester include dimethyl R-2-methyl glutarate available from Rhodia as Rhodiasolv Iris.

### Alkylpyridines

Suitable alkylpyridines include, without limitation, 2-monohydrocarbylpyridine, 3-monohydrocarbylpyridine, 4-monohydrocarbylpyridine, 2,3-dihydrocarbylpyridine, 2,4-dihydrocarbylpyridine, 2,5-dihydrocarbylpyridine, 2,6-dihydrocarbylpyridine, 3,4-dihydrocarbylpyridine, 3,5-dihydrocarbylpyridine, tri-hydrocarbylpyridines, tetrahydrocarbylpyridines, pentahydrocarbylpyridines, and mixtures or combinations thereof, where the hydrocarbyl groups may be linear, branched, saturated, unsaturated, aryl, alkaaryl, arylalkyl, or mixtures and combination thereof having between 1 and 20 carbon atoms, one or more carbon atoms may be replace by oxygen atoms. Alkylpyridines are suitable solvents for polyvinylpyridines. Exemplary examples of alkylpyridines include PAP-220 available from Vertellus Specialties Inc.

### Carriers

Suitable carriers for use in the present invention include, without limitation, low molecular weight alcohols having between 1 and 5 carbon atoms, where one or more of the carbon atoms may be oxygen or mixtures or combinations thereof. Exemplary examples include methanol, ethanol, propanol, isopropyl alcohol, butanol, isobutanol, pentanol, isopentanol, neopentanol, ethylene glycol, or mixture or combinations thereof.

### Solid Materials

Suitable solid materials suitable for being coated with the compositions of this invention include, without limitation, metal oxides and/or ceramics, natural or synthetic, metals, plastics and/or other polymeric solids, solid materials derived from plants, or any other solid material that does or may find use in downhole applications or mixtures or combinations thereof. Metal oxides including any solid oxide of a metallic element of the periodic table of elements. Exemplary examples of metal oxides and ceramics include actinium oxides, aluminum oxides, antimony oxides, boron oxides, barium oxides, bismuth oxides, calcium oxides, cerium oxides, cobalt oxides, chromium oxides, cesium oxides, copper oxides, dysprosium oxides, erbium oxides, europium oxides, gallium oxides, germanium oxides, iridium oxides, iron oxides, lanthanum oxides, lithium oxides, magnesium oxides, manganese oxides, molybdenum oxides, niobium oxides, neodymium oxides, nickel oxides, osmium oxides, palladium oxides, potassium oxides, promethium oxides, praseodymium oxides, platinum oxides, rubidium oxides, rhenium oxides, rhodium oxides, ruthenium oxides, scandium oxides, selenium oxides, silicon oxides, samarium oxides, silver oxides, sodium oxides, strontium oxides, tantalum oxides, terbium oxides, tellurium oxides, thorium oxides, tin oxides, titanium oxides, thallium oxides, thulium oxides, vanadium oxides, tungsten oxides, yttrium oxides, ytterbium oxides, zinc oxides, zirconium oxides, ceramic structures prepared from one or more of these oxides and mixed metal oxides including two or more of the above listed metal oxides. Exemplary examples of plant materials include, without limitation, shells of seed bearing plants such as walnut shells, pecan shells, peanut shells, shells for other hard shelled seed forming plants, ground wood or other fibrous cellulosic materials, or mixtures or combinations thereof.

Fibers and Organic Particulate Materials

Non-Erodible Fibers

Suitable non soluble or non erodible fibers include, without limitation, natural fibers, synthetic fibers, or mixtures and combinations thereof. Exemplary examples of natural fibers include, without limitation, abaca, cellulose, wool such as alpaca wool, cashmere wool, mohair, or angora wool, camel hair, coir, cotton, flax, hemp, jute, ramie, silk, sisal, byssus fibers, chiengora fibers, muskox wool, yak wool, rabbit hair, kapok, kenaf, raffia, bamboo, Piria, asbestos fibers, glass fibers, cellulose fibers, wood pulp fibers, treated analogs thereof, or mixtures and combinations thereof. Exemplary examples of synthetic fibers include, without limitation, regenerated cellulose fibers, cellulose acetate fibers, polyester fibers, acrylic fibers, fibre optic fibers, polyamide and polyester fibers, polyethylene fibers, polypropylene fibers, silk fibers, azlon fibers, BAN-LON® fibers (registered trademark of Joseph Bancroft & Sons Company), basalt fiber, carbon fiber, CELLIANT® fiber (registered trademark of Hologenix, LLC), cellulose acetate fiber, cellulose triacetate fibers, CORDURA® fibers (registered trademark of INVISTA, a subsidiary of privately owned Koch Industries, Inc.), crimplene (a polyester) fibers, cuben fibers, cuprammonium rayon fibers, dynel fibers, elasterell fibers, elastolefin fibers, glass fibers, GOLD FLEX® fibers (registered trademark of Honeywell), INNEGRA S™ fibers (brandname of Innegra Technologies LLC), aramid fibers such as KEVLAR® fibers (registered trademark of DuPont), KEVLAR® KM2 fibers (registered trademark of DuPont), LASTOL® fibers (registered trademark of DOW Chemicals Company), Lyocell fibers, M5 fibers, modacrylic fibers, Modal fibers, NOMEX® fibers (registered trademark of DuPont), nylon fibers such as nylon 4 fibers, nylon 6 fibers, nylon 6-6 fibers, polyolefin fibers, poly(p-phenylene sulfide) fibers, polyacrylonitrile fibers, polybenzimidazole fibers, polydioxanone fibers, polyester fibers, qiana fibers, rayon fibers, polyvinylidene chloride fibers such as Saran fibers, poly(trimethylene terephthalate) fibers such as Sorona fibers, spandex or elastane fibers, Taklon fibers, Technora fibers, THINSULATE® fibers (registered trademark of 3M), Twaron™ fibers (brandname of Teijin Aramid), ultra-high-molecular-weight polyethylene fibers, syndiotactic polypropylene fibers, isotactic polypropylene fibers, polyvinylalcohol fibers, cellulose xanthate fibers, poly(p-phenylene-2,6-benzobisoxazole) fibers, polyimide fibers, other synthetic fibers, or mixtures and combinations thereof. These fibers can additionally or alternatively form a three-dimensional network, reinforcing the proppant and limiting its flowback.

Non-Erodible Particles and Fibers

Suitable solid organic polymeric particulate materials include, without limitation, polymeric particulate matter derived from cellulose, acrylic acid, aramides, acrylonitrile, polyamides, vinylidene, olefins, diolefins, polyester, polyurethane, vinyl alcohol, and vinyl chloride, may be used. Preferred compositions, assuming the required reactivity and/or decomposition characteristics may be selected from rayon, acetate, triacetate, cotton, wool (cellulose group); nylon, acrylic, modacrylic, nitrile, polyester, saran, spandex, vinyon, olefin, vinyl, (synthetic polymer group); azlon, rubber (protein and rubber group), and mixtures thereof. Polyester and polyamide particles of sufficient molecular weight, such as from Dacron® and nylon, respectively, and mixtures thereof, are most preferred. Again, composite particles, comprising natural and/or synthetic materials of appropriate characteristics, may be employed. For example, a suitable composite particle might comprise a core and sheath structure where the sheath material and the core material degrade over different desired periods of time. The compounds or compositions employed as organic polymeric material according to the invention need not be pure, and commercially available materials containing various additives, fillers, etc. or having coatings may be used, so long as such components do not interfere with the required activity. The organic polymeric particulate material level, i.e., concentration, provided initially in the fluid may range from 0.02 percent up to about 10 percent by weight of the fluid. Most preferably, however, the concentration ranges from about 0.02 percent to about 5.0 percent by weight of fluid.

Particle size and shape, while important, may be varied considerably, depending on timing and transport considerations. In certain embodiments, if irregular or spherical particles of the organic polymer are used, particle size may range from 80 mesh to 2.5 mesh (Tyler), preferably from 60 mesh to 3 mesh. Fibers and/or platelets of the specified polymeric materials are preferred for their mobility and transfer aiding capability. In the case of fibers of the organic polymer, the fibers employed according to the invention may also have a wide range of dimensions and properties. As employed herein, the term “fibers” refers to bodies or masses, such as filaments, of natural or synthetic material(s) having one dimension significantly longer than the other two, which are at least similar in size, and further includes mixtures of such materials having multiple sizes and types. In other embodiments, individual fiber lengths may range upwardly from about 1 millimeter. Practical limitations of handling, mixing, and pumping equipment in wellbore applications, currently limit the practical use length of the fibers to about 100 millimeters. Accordingly, in other embodiments, a range of fiber length will be from about 1 mm to about 100 mm or so. In yet other embodiments, the length will be from at least about 2 mm up to about 30 mm. Similarly, fiber diameters will preferably range upwardly from about 5 microns. In other embodiments, the diameters will range from about 5 microns to about 40 microns. In other embodiments, the diameters will range from about 8 microns to about 20 microns, depending on the modulus of the fiber, as described more fully hereinafter. A ratio of length to diameter (assuming the cross section of the fiber to be circular) in excess of 50 is preferred. However, the fibers may have a variety of shapes ranging from simple round or oval cross-sectional areas to more complex shapes such as trilobe, figure eight, star-shape, rectangular cross-sectional, or the like. Preferably, generally straight fibers with round or oval cross sections will be used. Curved, crimped, branched, spiral-shaped, hollow, fibrillated, and other three dimensional fiber geometries may be used. Again, the fibers may be hooked on one or both ends. Fiber and platelet densities are not critical, and will preferably range from below 1 to 4 g/cm³ or more.

Those skilled in the art will recognize that a dividing line between what constitute “platelets”, on one hand, and “fibers”, on the other, tends to be arbitrary, with platelets being distinguished practically from fibers by having two dimensions of comparable size both of which are significantly larger than the third dimension, fibers, as indicated, generally having one dimension significantly larger than the other two, which are similar in size. As used herein, the terms “platelet” or “platelets” are employed in their ordinary sense, suggesting flatness or extension in two particular dimensions, rather than in one dimension, and also is understood to include mixtures of both differing types and sizes. In general, shavings, discs, wafers, films, and strips of the polymeric material(s) may be used. Conventionally, the term “aspect ratio” is understood to be the ratio of one dimension, especially a dimension of a surface, to another dimension. As used herein, the phrase is taken to indicate the ratio of the diameter of the surface area of the largest side of a segment of material, treating or assuming such segment surface area to be circular, to the thickness of the material (on average). Accordingly, the platelets utilized in the invention will possess an average aspect ratio of from about 10 to about 10,000. In certain embodiments the average aspect ratio is from 100 to 1000. In other embodiments, the platelets will be larger than 5 microns in the shortest dimension, the dimensions of a platelet which may be used in the invention being, for example, 6 mm×2 mm×15 mm.

In a particularly advantageous aspect of the invention, particle size of the organic polymeric particulate matter may be managed or adjusted to advance or retard the reaction or degradation of the gelled suspension in the fracture. Thus, for example, of the total particulate matter content, 20 percent may comprise larger particles, e.g., greater than 100 microns, and 80 percent smaller, say 80 percent smaller than 20 micron particles. Such blending in the gelled suspension may provide, because of surface area considerations, a different time of completion of reaction or decomposition of the particulate matter, and hence the time of completion of gel decomposition or breaking, when compared with that provided by a different particle size distribution.

The solid particulate matter, e.g., fibers, or fibers and/or platelet, containing fluid suspensions used in the invention may be prepared in any suitable manner or in any sequence or order. Thus, the suspension may be provided by blending in any order at the surface, and by addition, in suitable proportions, of the components to the fluid or slurry during treatment on the fly. The suspensions may also be blended offsite. In the case of some materials, which are not readily dispersible, the fibers should be “wetted” with a suitable fluid, such as water or a wellbore fluid, before or during mixing with the fracturing fluid, to allow better feeding of the fibers. Good mixing techniques should be employed to avoid “clumping” of the particulate matter.

Erodible Particles and Fibers

Suitable dissolvable, degradable, or erodible proppants include, without limitation, water-soluble solids, hydrocarbon-soluble solids, or mixtures and combinations thereof. Exemplary examples of water-soluble solids and hydrocarbon-soluble solids include, without limitation, salt, calcium carbonate, wax, soluble resins, polymers, or mixtures and combinations thereof. Exemplary salts include, without limitation, calcium carbonate, benzoic acid, naphthalene based materials, magnesium oxide, sodium bicarbonate, sodium chloride, potassium chloride, calcium chloride, ammonium sulfate, or mixtures and combinations thereof. Exemplary polymers include, without limitation, polylactic acid (PLA), polyglycolic acid (PGA), lactic acid/glycolic acid copolymer (PLGA), polysaccharides, starches, or mixtures and combinations thereof.

As used herein, “polymers” includes both homopolymers and copolymers of the indicated monomer with one or more comonomers, including graft, block and random copolymers. The polymers may be linear, branched, star, crosslinked, derivatized, and so on, as desired. The dissolvable or erodible proppants may be selected to have a size and shape similar or dissimilar to the size and shape of the proppant particles as needed to facilitate segregation from the proppant. Dissolvable, degradable, or erodible proppant particle shapes can include, for example, spheres, rods, platelets, ribbons, and the like and combinations thereof. In some applications, bundles of dissolvable, degradable, or erodible fibers, or fibrous or deformable materials, may be used.

The dissolvable, degradable, or erodible proppants may be capable of decomposing in the water-based fracturing fluid or in the downhole fluid, such as fibers made of polylactic acid (PLA), polyglycolic acid (PGA), polyvinyl alcohol (PVOH), and others. The dissolvable, degradable, or erodible fibers may be made of or coated by a material that becomes adhesive at subterranean formation temperatures. The dissolvable, degradable, or erodible fibers used in one embodiment may be up to 2 mm long with a diameter of 10-200 microns, in accordance with the main condition that the ratio between any two of the three dimensions be greater than 5 to 1. In another embodiment, the dissolvable, degradable, or erodible fibers may have a length greater than 1 mm, such as, for example, 1-30 mm, 2-25 mm or 3-18 mm, e.g., about 6 mm; and they can have a diameter of 5-100 microns and/or a denier of about 0.1-20, preferably about 0.15-6. These dissolvable, degradable, or erodible fibers are desired to facilitate proppant carrying capability of the treatment fluid with reduced levels of fluid viscosifying polymers or surfactants. Dissolvable, degradable, or erodible fiber cross-sections need not be circular and fibers need not be straight. If fibrillated dissolvable, degradable, or erodible fibers are used, the diameters of the individual fibrils maybe much smaller than the aforementioned fiber diameters.

### Compositional Ranges and Properties

Embodiments of the aggregating compositions of this invention include:

from about 5 wt. % to about 95 wt. % of aggregating compounds of this invention.

In certain embodiments of the aggregating compositions of this invention include:

from about 10 wt. % to about 90 wt. % of aggregating compounds of this invention.

In other embodiments of the aggregating compositions of this invention include:

from about 20 wt. % to about 80 wt. % of aggregating compounds of this invention.

In other embodiments of the aggregating compositions of this invention include:

from about 30 wt. % to about 70 wt. % of aggregating compounds of this invention.

In other embodiments of the aggregating compositions of this invention include:

from about 40 wt. % to about 60 wt. % of aggregating compounds of this invention.

In other embodiments of the aggregating compositions of this invention further include:

from about 5 wt. % to about 50 wt. % of a carrier,

where the weight percent may add to greater than 100 weight percent.

In other embodiments of the aggregating compositions of this invention further include:

from about 10 wt. % to about 40 wt. % of a carrier,

where the weight percent may add to greater than 100 weight percent.

In other embodiments of the aggregating compositions of this invention further include:

from about 10 wt. % to about 30 wt. % of a carrier,

where the weight percent may add to greater than 100 weight percent.

In other embodiments of the aggregating compositions of this invention further include:

from about 10 wt. % to about 25 wt. % of a carrier,

where the weight percent may add to greater than 100 weight percent.

In other embodiments of the aggregating compositions of this invention further include:

from about 1 wt % to about 30 wt. % of a glyme,

where the weight percent may add to greater than 100 weight percent.

In other embodiments of the aggregating compositions of this invention further include:

from about 1 wt % to about 25 wt. % of a glyme,

where the weight percent may add to greater than 100 weight percent.

In other embodiments of the aggregating compositions of this invention further include:

from about 1 wt % to about 20 wt. % of a glyme,

where the weight percent may add to greater than 100 weight percent.

In other embodiments of the aggregating compositions of this invention further include:

from about 1 wt. % to about 20 wt. % of an ethoxylated alcohol having an HLB value between about 6 and about 10,

where the weight percent may add to greater than 100 weight percent.

In other embodiments of the aggregating compositions of this invention further include:

from about 1 wt. % to about 10 wt. % of an ethoxylated alcohol having an HLB value between about 6 and about 10,

where the weight percent may add to greater than 100 weight percent.

In other embodiments of the aggregating compositions of this invention further include:

from about 1 wt. % to about 8 wt. % of an ethoxylated alcohol having an HLB value between about 6 and about 10,

where the weight percent may add to greater than 100 weight percent.

### EXPERIMENTS OF THE INVENTION

Acidic Hydroxyl Containing Compounds and/or Lewis Acid Reactions

The following examples illustrate aggregating compositions including (a) reaction products between amines and acidic hydroxyl containing compounds and/or Lewis acids, or mixtures and combinations thereof, (b) reaction products of polyamines and acidic hydroxyl containing compounds and/or Lewis acids, or mixtures and combinations thereof, (c) reaction products of polymeric amines and acidic hydroxyl containing compounds and/or Lewis acids, or mixtures and combinations thereof, (d) crosslinked reaction products, (e) reaction products of amines and epoxy containing compounds, (f) reaction products between amine-epoxy reaction products with acidic hydroxyl containing compounds and/or Lewis acids, or mixtures and combinations thereof (e) mixtures or combinations thereof.

### Example 1—AC1

92.00 g of Reilline 400 (a 4-ethenylpyridine homopolymer available from Vertellus Specialties Inc. and other suppliers), 46.00 g of Glycol Ether EB, and 46.00 g of ethylene glycol were weighed into a 400 mL beaker. These contents were stirred with a Calframo overhead stirrer for 10 minutes at 300 rpm. Then 16.22 g of a 50 wt. % citric acid aqueous solution were weighed into a plastic syringe and injected slowly at the beaker wall. The mixture was stirred for 90 more minutes. The final product had an amber transparent liquid and was designated AC1.

200.02 g of 100 mesh sand were weighed into a 400 mL beaker. 200 mL of a 2 wt. % KCl solution were added to the sand. Meanwhile, 15.43 g of AC1 were weighed into a plastic syringe. AC1 was added incrementally to the vortex of the sand and the 2 wt. % KCl being stirred at 450 rpm with the Calframo overhead stirrer. Then that treated sand composition was stirred for an additional 60 s and the liquid decanted. 200 mL of the 2 wt. % KCl solution were added to the AC1 agglomerated sand, stirred for 60 s and the liquid decanted. This washing step was repeated two more times. On the last washing, the contents were poured into a 16 ounce bottle, topped off with additional 2 wt. % KCl solution and capped. The AC1 agglomerated sand was beige and when the bottle was inverted the AC1 agglomerated sand descended slowly and as one piece.

### Example 2—AC2

92.12 g of Reilline 400 (a 4-ethenylpyridine homopolymer available from Vertellus Specialties Inc. and other suppliers), 22.77 g of methanol, and 46.00 g of ethylene glycol were weighed into a 400 mL beaker. These contents were stirred with a Calframo overhead stirrer for 10 minutes at 300 rpm. Meanwhile, 10 g of boric acid were dissolved in 101.7 g of methanol to give a 9.0 wt. % boric acid in methanol solution. 25.89 g of the 9.0 wt. % boric acid solution was weighed into a plastic syringe and injected slowly at the beaker wall. The mixture was stirred for 90 more minutes. The final product was an amber transparent liquid and designated AC2.

200.04 g of 100 mesh sand were weighed into a 400 mL beaker. 200 mL of a 2 wt. % KCl solution were added to the sand. Meanwhile, 15.45 g of AC2 were weighed into a plastic syringe. AC2 was added incrementally to the vortex of the sand and the 2 wt. % KCl solution being stirred at 450 rpm with the Calframo overhead stirrer.

Eventually the vortex closed, the sand was viscosified and the sand sunk to the bottom of the beaker during the stirring process. Then the mixture was stirred for an additional 60 s and the liquid decanted. 200 mL of the 2 wt. % KCl solution were added to the AC2 agglomerated sand, stirred for 60 s and the liquid decanted. This washing step was repeated two more times. On the last washing, the contents were poured into a 16 ounce bottle, topped off with additional 2 wt. % KCl solution and capped. The AC2 agglomerated sand was beige and when the bottle was inverted the AC2 agglomerated sand descended slowly and as one piece.

### Example 3—AC3

92.03 g of Reilline 400 (a 4-ethenylpyridine homopolymer available from Vertellus Specialties Inc. and other suppliers), 58.03 g of methanol, and 34.02 g of ethylene glycol were weighed into a 400 mL beaker. These contents were stirred with a Calframo overhead stirrer for 10 minutes at 300 rpm. Then 18.87 g of a 40 wt. % aminoethylethanolamine tris(methylene phosphonic acid) aqueous solution were weighed into a plastic syringe and injected slowly at the beaker wall. The mixture was stirred for 90 more minutes. The final product was an amber transparent liquid and was designated AC3.

200.04 g of 100 mesh sand were weighed into a 400 mL beaker. 200 mL of a 2 wt. % KCl solution were added to the sand. Meanwhile, 15.56 g of AC3 were weighed into a plastic syringe. AC3 was added incrementally to the vortex of the sand and the 2 wt. % KCl solution being stirred at 450 rpm with the Calframo overhead stirrer.

Eventually the vortex closed, the sand was viscosified and the sand dropped to the bottom of the beaker during the stirring process. Then mixture was stirred for an additional 60 seconds and the liquid decanted. 200 mL of a 2 wt. % KCl solution were added to the AC3 agglomerated sand, stirred for 60 s and the liquid decanted. This washing step was repeated two more times. On the last washing, the contents were poured into a 16 ounce bottle, topped off with additional 2 wt. % KCl solution and capped. The AC3 agglomerated sand was beige. When the bottle was inverted, the AC3 agglomerated sand descended slowly and as one piece.

### Example 4—AC4

92.05 g of Reilline 400 (a 4-ethenylpyridine homopolymer available from Vertellus Specialties Inc. and other suppliers), 46.32 g of methanol and 46.32 g of ethylene glycol were weighed into a 400 mL beaker. These contents were stirred with a Calframo overhead stirrer for 10 minutes at 300 rpm. Then 23.59 g of an aqueous solution of 48% diethylenetriamine penta(methylene phosphonic acid) was weighed into a plastic syringe and injected slowly at the beaker wall. The mixture was stirred for 90 more minutes. The final product was an amber transparent liquid and is designated AC4.

200.03 g of 100 mesh sand were weighed into a 400 mL beaker. 200 mL of a 2 wt. % KCl solution were added to the sand. Meanwhile, 15.47 g of AC4 were weighed into a plastic syringe. AC4 was added incrementally to the vortex of the sand and the 2 wt. % KCl solution being stirred at 450 rpm with the Calframo overhead stirrer.

Eventually the vortex closed, the sand was viscosified and the sand dropped to the bottom of the beaker during the stirring process. Then that composition was stirred for an additional 60 seconds and the liquid decanted. 200 mL of a 2 wt. % KCl solution was added to the AC4 agglomerated sand, stirred for 60 seconds and the liquid decanted. This washing step was repeated two more times. On the last washing, the contents were poured into a 16 ounce bottle, topped off with additional 2 wt. % KCl solution and capped. The AC4 agglomerated sand was beige. When the bottle was inverted, the AC4 agglomerated sand descended slowly and as one piece.

### Example 5—AC5

40.04 g of Reilline 400 (a 4-ethenylpyridine homopolymer available from Vertellus Specialties Inc. and other suppliers), 70.11 g of PAP-220, 40.94 g of methanol and 40.19 g of ethylene glycol were weighed into a 400 mL beaker. These contents were stirred with a Calframo overhead stirrer for 10 minutes at 300 rpm. Then 23.50 g of an aqueous solution of 5M ZnCl₂ was weighed into a plastic syringe and injected slowly at the beaker wall. The mixture was stirred for 90 more minutes. The final product was designated AC5.

200.00 g of 20/40 sand were weighed into a 400 mL beaker. 200 mL of 2 wt. % KCl was added to the sand. Meanwhile, 15.4 g of AC5 were weighed into a plastic syringe. The blend was added incrementally to the vortex of the sand and a 2 wt. % ZnCl₂ solution being stirred at 450 rpm with the Calframo overhead stirrer. Then mixture was stirred for an additional 60 s and the liquid decanted. 200 mL of a 2 wt. % ZnCl₂ solution was added to the AC5 agglomerated sand, stirred for 60 s and the liquid decanted. This washing step was repeated two more times.

### Comparative Example 1—CE1

40.02 g of Reilline 400 (a 4-ethenylpyridine homopolymer available from Vertellus Specialties Inc. and other suppliers), 70.08 g of PAP-220, 42.84 g of methanol and 40.44 g of ethylene glycol were weighed into a 400 mL beaker. These contents were stirred with a Calframo overhead stirrer for 10 minutes at 300 rpm. Then 16.04 g of Alpha 2240 were weighed into a plastic syringe and injected slowly at the beaker wall. The mixture was stirred for 90 more minutes. The final product was designated CE1.

200.0 g of 20/40 sand were weighed into a 400 mL beaker. 200 mL of a 2 wt. % KCl solution were added to the sand. Meanwhile, 15.4 g of CE1 were weighed into a plastic syringe. The blend was added incrementally to the vortex of the sand and 2 wt. % KCl being stirred at 450 rpm with the Calframo overhead stirrer. Then that composition was stirred for an additional 60 s and the liquid decanted. 200 mL of the 2 wt. % KCl solution were added to the CE1 agglomerated sand, stirred for 60 s and the liquid decanted. This washing step was repeated two more times.

### Example 6—Indentation Force Testing

Indentation force in Newtons of the washed agglomerated 20/40 sands were measured with a Shimpo Model FGS-100H Manual Hand Wheel Test Stand equipped with Toriemon USB Add-in software for Excel. Sampling rate was 10 times/second. Initial force was 0.25 Newtons. TempoPerfect Metroneme Software was used to control the rate of the wheel rotation at 60 bpm. The testing data is tabulated in Table 1.

TABLE 1
Indentation Force Data

| Example | Force in Newtons |
|---|---|
| CE1 | 4.97 |
| AC5 | 12.42 |

The indentation force for Example 5 (AC5) was more than twice that of the comparative example (CE1).

### Example 7—AC7

92.03 g of Reilline 400 (a 4-ethenylpyridine homopolymer available from Vertellus Specialties Inc. and other suppliers), 46.03 g of methanol and 46.03 g of ethylene glycol were weighed into a 400 mL beaker. These contents were stirred with a Calframo overhead stirrer for 10 minutes at 300 rpm. Then 14.76 g of Westvaco Diacid 1550 was weighed into a plastic syringe and injected slowly at the beaker wall. The mixture was stirred for 90 more minutes. The final product was an amber transparent liquid and was designated AC7.

200.06 g of 100 mesh sand was weighed into a 400 mL beaker. 200 mL of 2 wt. % KCl was added to the sand. Meanwhile, 15.44 g of AC7 were weighed into a plastic syringe. AC7 was added incrementally to the vortex of the sand and 2 wt. % KCl being stirred at 450 rpm with the Calframo overhead stirrer. Eventually the vortex closed, the sand was viscosified and the sand dropped to the bottom of the beaker during the stirring process. Then mixture was stirred for an additional 60 s and the liquid decanted. 200 mL of 2 wt. % KCl was added to the AC7 agglomerated sand, stirred for 60 s and the liquid decanted. This washing step was repeated two more times. On the last washing, the contents were poured into a 16 ounce bottle, topped off with additional 2 wt. % KCl solution and capped. The AC7 agglomerated sand was beige. When the bottle was inverted, the AC7 agglomerated sand descended slowly and as one piece.

### Example 8—AC8

92.03 g of Reilline 400 (a 4-ethenylpyridine homopolymer available from Vertellus Specialties Inc. and other suppliers), 7.62 g of Dowanol EB and 46.17 g of ethylene glycol were weighed into a 400 mL beaker. These contents were stirred with a Calframo overhead stirrer for 10 minutes at 300 rpm. Meanwhile, 29.17 g of Tenax 2010 was dissolved in Glycol Ether EB to give a 28.28 wt. % solution of Tenax 2010 in Dowanol EB. Then 53.75 g of the 28.28 wt. % solution of Tenax 2010 in Dowanol EB was weighed into a plastic syringe and injected slowly at the beaker wall. The mixture was stirred for 90 more minutes. The final product was an amber transparent liquid and was designated AC8.

200.03 g of 100 mesh sand was weighed into a 400 mL beaker. 200 mL of 2 wt. % KCl was added to the sand. Meanwhile, 15.45 g of AC8 were weighed into a plastic syringe. AC8 was added incrementally to the vortex of the sand and 2 wt. % KCl being stirred at 450 rpm with the Calframo overhead stirrer. Eventually the vortex closed, the sand was viscosified and the sand dropped to the bottom of the beaker during the stirring process. The mixture was stirred for an additional 60 s and the liquid decanted. 200 mL of 2 wt. % KCl was added to the AC8 agglomerated sand, stirred for 60 seconds and the liquid decanted. This washing step was repeated two more times. On the last washing, the contents were poured into a 16 ounce bottle, topped off with additional 2 wt. % KCl solution and capped. The AC8 agglomerated sand was beige with no apparent odor. When the bottle was inverted, the AC8 agglomerated sand descended slowly and as one piece.

### Example 9—AC9

92.02 g of Reilline 400 (a 4-ethenylpyridine homopolymer available from Vertellus Specialties Inc. and other suppliers), 37.81 g of methanol and 46.01 g of ethylene glycol were weighed into a 400 mL beaker. These contents were stirred with a Calframo overhead stirrer for 10 minutes at 300 rpm. Meanwhile, 30.00 g of maleic acid was dissolved in 50.09 g of methanol to give a 37.46 wt. % solution of maleic acid in methanol. Then 13.12 g of the 37.46 wt. % solution of maleic acid in methanol was weighed into a plastic syringe and injected slowly at the beaker wall. The mixture was stirred for 90 more minutes. The final product was an amber transparent liquid and was designated AC9.

200.09 g of 100 mesh sand was weighed into a 400 mL beaker. 200 mL of 2 wt. % KCl was added to the sand. Meanwhile, 15.46 g of AC9 were weighed into a plastic syringe. AC9 was added incrementally to the vortex of the sand and 2 wt. % KCl being stirred at 450 rpm with the Calframo overhead stirrer. Eventually the vortex closed, the sand was viscosified and the sand dropped to the bottom of the beaker during the stirring process. The mixture was stirred for an additional 60 s and the liquid decanted. 200 mL of 2 wt. % KCl was added to the AC9 agglomerated sand, stirred for 60 s and the liquid decanted. This washing step was repeated two more times. On the last washing, the contents were poured into a 16 ounce bottle, topped off with additional 2 wt. % KCl solution and capped. The AC9 agglomerated sand was beige. When the bottle was inverted, the AC9 agglomerated sand descended slowly and as one piece.

### Example 10—AC10

92.05 g of Reilline 400 (a 4-ethenylpyridine homopolymer available from Vertellus Specialties Inc. and other suppliers) and 46.40 g of ethylene glycol were weighed into a 400 mL beaker. These contents were stirred with a Calframo overhead stirrer for 10 minutes at 300 rpm. Meanwhile, 13.03 g of succinic acid was dissolved in 139.25 g of methanol to give an 8.56 wt. % solution of succinic acid in methanol. Then 53.18 g of the 8.56 wt. % solution of succinic acid in methanol was weighed into a plastic syringe and injected slowly at the beaker wall. The mixture was stirred for 90 more minutes. The final product was an amber transparent liquid with minimal odor and was designated AC10.

200.09 g of 100 mesh sand was weighed into a 400 mL beaker. 200 mL of 2 wt. % KCl was added to the sand. Meanwhile, 15.46 g of AC10 were weighed into a plastic syringe. The blend was added incrementally to the vortex of the sand and 2 wt. % KCl being stirred at 450 rpm with the Calframo overhead stirrer. Eventually the vortex closed, the sand was viscosified and the sand dropped to the bottom of the beaker during the stirring process. Then mixture was stirred for an additional 60 s and the liquid decanted. 200 mL of the 2 wt. % KCl solution was added to the agglomerated sand, stirred for 60 s and the liquid decanted. This washing step was repeated two more times. On the last washing, the contents were poured into a 16 ounce bottle, topped off with additional 2 wt. % KCl solution and capped. The AC10 agglomerated sand was beige. When the bottle was inverted, the AC10 agglomerated sand descended slowly and as one piece.

### Example 11—AC11

92.04 g of Reilline 400 (a 4-ethenylpyridine homopolymer available from Vertellus Specialties Inc. and other suppliers) and 46.40 g of ethylene glycol were weighed into a 400 mL beaker. These contents were stirred with a Calframo overhead stirrer for 10 minutes at 300 rpm. Meanwhile, 13.08 g of adipic acid was dissolved in 140.11 g of methanol to give an 8.53 wt. % solution of adipic acid in methanol. Then 72.28 g of the 8.53 wt. % solution of adipic acid in methanol was weighed into a plastic syringe and injected slowly at the beaker wall. The mixture was stirred for 90 more minutes. The final product was an amber transparent liquid and was designated AC11.

200.01 g of 100 mesh sand was weighed into a 400 mL beaker. 200 mL of 2 wt. % KCl was added to the sand. Meanwhile, 15.42 g of AC11 were weighed into a plastic syringe. The blend was added incrementally to the vortex of the sand and 2 wt. % KCl being stirred at 450 rpm with the Calframo overhead stirrer. The vortex disappeared after addition of 7 mL of the Reilline 400 and adipic acid blend and the sand dropped to the bottom of the beaker during the stirring process. Then that composition was stirred for an additional 60 seconds and the liquid decanted. 200 mL of the 2 wt. % KCl solution was added to the AC11 agglomerated sand, stirred for 60 s and the liquid decanted. This washing step was repeated two more times. On the last washing, the contents were poured into a 16 ounce bottle, topped off with additional 2 wt. % KCl solution and capped. The AC11 agglomerated sand was beige. When the bottle was inverted, the AC11 agglomerated sand descended slowly and as one piece.

### Example 12—AC12

92.01 g of Reilline 400 (a 4-ethenylpyridine homopolymer available from Vertellus Specialties Inc. and other suppliers), 25.58 g of methanol and 46.02 g of ethylene glycol were weighed into a 400 mL beaker. These contents were stirred with a Calframo overhead stirrer for 10 minutes at 300 rpm. Meanwhile, 25.60 g of tricarballylic acid was dissolved in 70.44 g of methanol to give a 26.65 wt. % solution of carballylic acid in methanol. Then 27.91 g of the 26.65 wt. % solution of carballylic acid in methanol was weighed into a plastic syringe and injected slowly at the beaker wall. The mixture was stirred for 90 more minutes. The final product was an amber transparent liquid with a sweet odor and was designated AC12.

200.05 g of 100 mesh sand was weighed into a 400 mL beaker. 200 mL of 2 wt. % KCl was added to the sand. Meanwhile, 15.43 g of AC12 were weighed into a plastic syringe. The blend was added incrementally to the vortex of the sand and 2 wt. % KCl being stirred at 450 rpm with the Calframo overhead stirrer. The vortex disappeared after the addition of 5 mL of the reaction product of Reilline 400 and carballylic acid in methanol and ethylene glycol and the sand dropped to the bottom of the beaker after the addition of 5 mL of the reaction product of Reilline 400 and carballylic acid during the stirring process. Then that composition was stirred for an additional 60 seconds and the liquid decanted. 200 mL of the 2 wt. % KCl solution was added to the AC12 agglomerated sand, stirred for 60 s and the liquid decanted. This washing step was repeated two more times. On the last washing, the contents were poured into a 16 ounce bottle, topped off with additional 2 wt. % KCl and capped. The AC12 agglomerated sand was beige. When the bottle was inverted, the AC12 agglomerated sand descended slowly and as one piece.

### Example 13—AC13

92.05 g of Reilline 400 (a 4-ethenylpyridine homopolymer available from Vertellus Specialties Inc. and other suppliers), 35.89 g of methanol and 46.00 g of ethylene glycol were weighed into a 400 mL beaker. These contents were stirred with a Calframo overhead stirrer for 10 minutes at 300 rpm. Meanwhile, 14.19 g of p-toluene sulfonic acid monohydrate was dissolved in 18.04 g of methanol to give a 44.03 wt. % solution of p-toluene sulfonic acid monohydrate in methanol. Then 18.28 g of the 44.03 wt. % solution of p-toluene sulfonic acid monohydrate in methanol was weighed into a plastic syringe and injected slowly at the beaker wall. The mixture was stirred for 90 more minutes. The final product was an amber transparent liquid and was designated AC13.

200.04 g of 100 mesh sand was weighed into a 400 mL beaker. 200 mL of 2 wt. % KCl was added to the sand. Meanwhile, 15.43 g of AC13 were weighed into a plastic syringe. The blend was added incrementally to the vortex of the sand and 2 wt. % KCl being stirred at 450 rpm with the Calframo overhead stirrer. The vortex disappeared early and the sand dropped to the bottom of the beaker during the stirring process. Then mixture was stirred for an additional 60 s and the liquid decanted. 200 mL of the 2 wt. % KCl solution was added to the AC13 agglomerated sand, stirred for 60 s and the liquid decanted. This washing step was repeated two more times. On the last washing, the contents were poured into a 16 ounce bottle, topped off with additional 2 wt. % KCl solution and capped. The AC13 agglomerated sand was beige. When the bottle was inverted, the AC13 agglomerated sand descended slowly and as one piece.

### Example 14—AC14

92.05 g of Reilline 400 (a 4-ethenylpyridine homopolymer available from Vertellus Specialties Inc. and other suppliers), 43.36 g of methanol and 46.03 g of ethylene glycol were weighed into a 400 mL beaker. These contents were stirred with a Calframo overhead stirrer for 10 minutes at 300 rpm. Meanwhile, 21.72 g of glacial acetic acid was dissolved in 21.74 g of methanol to give a 49.98 wt. % solution of glacial acetic acid in methanol. Then 5.08 g of the 49.98 wt. % solution of glacial acetic acid in methanol was weighed into a plastic syringe and injected slowly at the beaker wall. The mixture was stirred for 90 more minutes. The final product was an amber transparent liquid and was designated AC14.

200.03 g of 100 mesh sand was weighed into a 400 mL beaker. 200 mL of 2 wt. % KCl was added to the sand. Meanwhile, 15.41 g of AC14 were weighed into a plastic syringe. The AC14 was added incrementally to the vortex of the sand and 2 wt. % KCl being stirred at 450 rpm with the Calframo overhead stirrer. The vortex disappeared early and the sand dropped to the bottom of the beaker during the stirring process. Then mixture was stirred for an additional 60 s and the liquid decanted.

200 mL of the 2 wt. % KCl solution was added to the AC14 agglomerated sand, stirred for 60 s and the liquid decanted. This washing step was repeated two more times. On the last washing, the contents were poured into a 16 ounce bottle, topped off with additional 2 wt. % KCl solution and capped. The AC14 agglomerated sand was beige. When the bottle was inverted, the AC14 agglomerated sand descended slowly and as one piece.

### Example 15—AC15

92.03 g of HAP-310 from Vertellus Specialties Inc., 46.21 g Dowanol DPM glycol ether, and 46.05 g ethylene glycol were weighed into a 400 mL beaker. These contents were stirred with a Calframo overhead stirrer for 10 minutes at 300 rpm. Then 16.24 g of a 50.0 wt. % solution of citric acid in water were weighed into a plastic syringe and injected slowly at the beaker wall. The mixture was stirred for 90 more minutes. The final product was a black opaque liquid and was designated AC15.

200.08 g of 100 mesh sand were weighed into a 400 mL beaker. 200 mL of a 2 wt. % KCl solution were added to the sand. Meanwhile, 15.45 g of AC15 were weighed into a plastic syringe. The AC15 was added incrementally to the vortex of the sand and 2 wt. % KCl solution being stirred at 450 rpm with the Calframo overhead stirrer. The vortex disappeared after 5.45 g of AC15 were added and the sand dropped during the stirring process. The remaining 10 g of AC15 were added during the stirring process. Then that composition was stirred for an additional 60 seconds and the liquid decanted.

200 mL of 2 wt. % KCl solution were added to the AC15 agglomerated sand, stirred for 60 seconds and the liquid decanted. This washing step was repeated two more times. On the last washing, the contents were poured into a 16 ounce bottle, topped off with additional 2 wt. % KCl solution and capped. The AC15 agglomerated sand was black with a strong alkyl pyridine odor. When the bottle was inverted the next day, the AC15 agglomerated sand descended slowly as one piece.

### Example 16—AC16

92.06 g of HAP-310 from Vertellus Specialties Inc., 37.85 g of methanol, and 46.00 g ethylene glycol were weighed into a 400 mL beaker. The viscosity of the HAP-310 was determined to be 6899 cps at 25° C. with a Brookfield DV-II Pro viscometer equipped with a small sample adapter, circulating bath and spindle S-34. These contents were stirred with a Calframo overhead stirrer for 10 minutes at 300 rpm. Meanwhile, 30.06 g maleic acid was dissolved in 50.05 g methanol to give a 37.52 wt. % solution of maleic acid in methanol. Then 13.09 g of the 37.5 wt. % solution of maleic anhydride in water were weighed into a plastic syringe and injected slowly at the beaker wall. The mixture was stirred for 90 more minutes. The final product was a black opaque liquid and was designated AC16.

200.00 grams of 100 mesh sand was weighed into a 400 ml beaker. 200 mL of 2 wt. % KCl were added to the sand. Meanwhile, 15.48 g of AC16 were weighed into a plastic syringe. The AC16 was added incrementally to the vortex of the sand and a 2 wt. % KCl solution being stirred at 450 rpm with the Calframo overhead stirrer. The vortex disappeared after 4.26 grams of AC16 were added during the stirring process. The remaining 11.22 g of AC16 were added during the stirring process. Then that mixture was stirred for an additional 60 seconds and the liquid decanted.

200 mL of 2 wt. % KCl solution were added to the AC16 agglomerated sand, stirred for 60 seconds and the liquid decanted. This washing step was repeated two more times. On the last washing, the contents were poured into a 16 ounce bottle, topped off with additional 2 wt. % KCl solution and capped. The AC16 agglomerated sand was black. When the bottle was inverted a day later, the AC16 agglomerated sand descended slowly as one piece then broke into two pieces.

### Example 17—AC17

92.06 g HAP-310 from Vertellus Specialties Inc., 46.75 g Dowanol DPM glycol ether, and 46.00 g ethylene glycol were weighed into a 400 mL beaker. The viscosity of the HAP-310 was determined to be 6899 cps at 25° C. with a Brookfield Dy-II Pro viscometer equipped with a small sample adapter, circulating bath and spindle S-34. These contents were stirred with a Calframo overhead stirrer for 10 minutes at 300 rpm. Then 14.84 g of Westvaco Diacid 1550 was weighed into a plastic syringe and injected slowly at the beaker wall. The mixture was stirred for 90 more minutes. The final product was a black opaque liquid with a strong alkyl pyridine odor and was designated AC17.

200.00 g of 100 mesh sand was weighed into a 400 mL beaker. 200 mL of a 2 wt. % KCl solution was added to the sand. Meanwhile, 15.48 g AC17 were weighed into a plastic syringe. The AC17 was added incrementally to the vortex of the sand and 2 wt. % KCl solution being stirred at 450 rpm with the Calframo overhead stirrer. The vortex disappeared after 5.02 g of AC17 were added. The remaining 10.46 g of AC17 were added during the stirring process. Then that mixture was stirred for an additional 60 seconds and the liquid decanted.

200 mL of 2 wt. % KCl solution were added to the AC17 agglomerated sand, stirred for 60 seconds and the liquid decanted. This washing step was repeated two more times. On the last washing, the contents were poured into a 16 ounce bottle, topped off with additional 2 wt. % KCl solution and capped. The AC17 agglomerated sand was black. When the bottle was inverted a day later, the AC17 agglomerated sand descended slowly as one piece, then broke into two pieces and each piece crumbled.

### Example 18—AC18

46.02 g HAP-310 and 46.03 grams PAP-220 from Vertellus Specialties Inc., 46.38 g methanol, and 46.22 g ethylene glycol were weighed into a 400 mL beaker. These contents were stirred with a Calframo overhead stirrer for 10 minutes at 300 rpm. Then 14.80 g of Westvaco Diacid 1550 were weighed into a plastic syringe and injected slowly at the beaker wall. The mixture was stirred for 90 more minutes. The final product was a black opaque liquid and was designated AC18.

200.06 g of 100 mesh sand was weighed into a 400 mL beaker. 200 mL of a 2 wt. % KCl solution were added to the sand. Meanwhile, 15.48 g of AC18 were weighed into a plastic syringe. The AC18 were added incrementally to the vortex of the sand and 2 wt. % KCl solution being stirred at 450 rpm with the Calframo overhead stirrer. The vortex disappeared after 2.54 g of AC18 were added during the stirring process. The remaining 12.94 g of AC18 were then added. Then that mixture was stirred for an additional 60 seconds and the liquid decanted.

200 milliliters of 2 wt. % KCl was added to the AC18 agglomerated sand, stirred for 60 seconds and the liquid decanted. This washing step was repeated two more times. On the last washing, the contents were poured into a 16 ounce bottle, topped off with additional 2 wt. % KCl solution and capped. The AC18 agglomerated sand was black. When the bottle was inverted a day later, the AC18 agglomerated sand descended slowly as one piece, then crumbled.

### Comparative Example 2—CE2

92.05 g of HAP-310 from Vertellus Specialties Inc., 46.03 g of methanol, and 46.07 g of ethylene glycol were weighed into a 400 mL beaker. The viscosity of the HAP-310 was determined to be 6899 cps at 25° C. with a Brookfield DV-II Pro viscometer equipped with a small sample adapter, circulating bath and spindle S-34. These contents were stirred with a Calframo overhead stirrer for 10 minutes at 300 rpm. No organic acid was added. The mixture was stirred for 90 more minutes. The final product was a black opaque liquid and was designated CE2.

200.04 g of 100 mesh sand was weighed into a 400 mL beaker. 200 mL of a 2 wt. % KCl solution were added to the sand. Meanwhile, 15.43 g of CE2 were weighed into a plastic syringe. The CE2 was added incrementally to the vortex of the sand and 2 wt. % KCl solution being stirred at 450 rpm with the Calframo overhead stirrer. The vortex disappeared after 6.4 g of CE2 were added and the sand dropped a ¼ inch during the stirring process. The remaining 9.03 g of CE2 were added during the stirring process. Then that composition was stirred for an additional 60 seconds and the liquid decanted.

200 mL of 2 wt. % KCl solution were added to the agglomerated sand, stirred for 60 seconds and the liquid decanted. This washing step was repeated two more times. On the last washing, the contents were poured into a 16 ounce bottle, topped off with additional 2 wt. % KCl solution and capped. The CE2 agglomerated sand was black. When the bottle was inverted a day later, the CE2 agglomerated sand descended slowly as one piece, then broke into two pieces and then each piece crumbled.

### Example 19—Comparative Indentation Testing

Indentation force (g) was measured at 25° C. with a TA HD Plus Texture Analyser from Texture Technologies Corp. The test mode was compression, the pre-test speed was 3.0 mm/s, test speed was 2.0 mm/s, post-test speed was 10 mm/s, target was distance, distance was 10.0 mm and trigger force was 5.0 g. The 2 wt. % KCL solution was decanted and each agglomerated 100 mesh sand was transferred to a mold or vessel, where it was compressed at 500 foot pounds with a Carver press. Four indentation measurements were obtained per sample and then averaged. The testing data is tabulated in Table 2.

TABLE 2
Indentation Force Measurements

| Samples | Average Force (g) |
|---|---|
| CE2 | 229 |
| AC15 | 373 |
| AC16 | 282 |

CE2 was agglomerated without an organic acid or phosphate ester. The alkylpyridines in CE2 are protonated from water in the washing and decanting steps with 2 wt. % KCl solution. AC15 and AC16 were protonated with an organic acid. More indentation force was observed when protonated with an organic acid.

### Epoxy-Modified Amines

### Example 20—AE1

In a bottle, 33 g of aminoethylpiperazine, 50 g bisphenol-A diglycidyl ether, and 150 g methanol were mixed in a beaker and stirred at 300 rpm with a Calframo overhead stirrer overnight and the epoxy modified amine reaction product was designated AE1.

200 g of 100 mesh sand were weighed into a 400 mL beaker. 200 mL of a 2 wt. % KCl solution were added to the sand. Meanwhile, 14 mL of AE1 were added incrementally to a mixing vortex of the sand in the 2 wt. % KCl solution, which was being stirred at 450 rpm with a Calframo overhead stirrer. The vortex disappeared as AE1 was added to the sand in the KCl solution. The mixture was then stirred for an additional 60 s and the liquid decanted from the sand.

200 mL of the 2 wt. % KCl solution were added to the AE1 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the AE1 agglomerated sand descended slowly and as one or two pieces as compared to untreated sand which fell as individual sand grains.

### Example 21—AE2

In a bottle, 50 g of PAP 220, 30 g bisphenol-A diglycidyl ether, and 25 g RhodiaSolv IRIS were sealed in a bottle and placed in a 180° F. water bath overnight. The reaction mixture was then transferred to a beaker to which were added 80 g methanol and 80 g ethylene glycol and the mixture stirred at 300 rpm with a Calframo overhead stirrer. To this, 4 g of phosphate ester were added slowly and mixing continued for 1 hour and the reaction product was designated AE2.

200 g of 100 mesh sand were weighed into a 400 mL beaker. 200 mL of a 2 wt. % KCl solution were added to the sand. Meanwhile, 14 mL of AE2 were added incrementally to a mixing vortex of the sand in the 2 wt. % KCl solution, which was being stirred at 450 rpm with the Calframo overhead stirrer. The vortex disappeared as AE2 was added to the sand in the KCl solution. The mixture was then stirred for an additional 60 s and the liquid decanted from the sand.

200 mL of the 2 wt. % KCl solution were added to the AE2 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the AE2 agglomerated sand descended slowly and as one piece as compared to untreated sand which fell as individual sand grains.

### Example 22—AE3

To a beaker were added 25 g of AE1 and 25 g of ethylene glycol and the mixture stirred at 300 rpm with a Calframo overhead stirrer. Next, 4 g of phosphate ester were added slowly and stirring was continued for 1 hour (AE3).

50 grams of 20/40 mesh sand were weighed into a 250 mL beaker. 50 mL of a 2 wt. % KCl solution was added to the sand. Meanwhile, 3.5 mL of AE3 were added incrementally to a mixing vortex of the sand in the 2 wt. % KCl solution, which was being stirred at 450 rpm with the Calframo overhead stirrer. The vortex disappeared as AE3 was added to the sand in the KCl solution. The mixture was then stirred for an additional 60 s and the liquid decanted from the sand.

50 mL of the 2 wt. % KCl solution were added to the AE3 agglomerated sand, stirred for 60 s and the liquid decanted. This washing step was repeated two more times. On the last washing step, the contents were poured into a 8 ounce bottle, topped off with additional 2 wt. % KCl solution and capped. When the bottle was inverted, the AE3 agglomerated sand descended slowly and as one piece as compared to untreated sand which fell as individual sand grains.

The following examples illustrate aggregating compositions including (a) polymers having N-oxide monomeric units, (b) polymers having N-oxide monomeric units and Lewis acid reaction products, (c) crosslinked polymers having N-oxide monomeric units, and (d) mixtures or combinations thereof.

### Polymers and Oligomers Including N-Oxide Groups and Quaternary Groups

The following examples illustrate aggregating compositions including (a) polymers having N-oxide monomeric units, (b) polymers having N-oxide monomeric units and Lewis acid reaction products, (c) crosslinked polymers having N-oxide monomeric units, and (d) mixtures or combinations thereof.

### Example 23—P1

92.03 grams of a 25 wt. % solution of 15% partially oxidized poly-4-vinylpyridine, 46.11 g of Glycol Ether EB, and 46.19 g of ethylene glycol were weighed into a 400 mL beaker. The degree of oxidation of the 15% partially oxidized poly-4-vinylpyridine was measured by NMR. The concentration of the 15% partially oxidized poly-4-vinylpyridine was measured by thermogravimetric analysis (TGA). These contents were stirred with a Calframo overhead stirrer for 10 minutes at 300 rpm. Then, 18.65 g of Phosphated DA-6 available from Manufacturing Chemicals LLC were weighed into a plastic syringe and injected slowly at the beaker wall. The mixture was stirred for 90 minutes. The final product was an amber transparent liquid designated P1.

200.00 grams of 100 mesh sand were weighed into a 400 mL beaker. 200 mL of a 2 wt. % KCl solution was added to the sand. Meanwhile, 18.71 g of P1 were weighed into a plastic syringe and then added incrementally to a mixing vortex of the sand in the 2 wt. % KCl solution, which was being stirred at 450 rpm with the Calframo overhead stirrer. The vortex disappeared as P1 was added to the sand in the KCl solution. The mixture was then stirred for an additional 60 s and the liquid decanted from the sand. 200 mL of the 2 wt. % KCl solution were added to the P1 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the P1 agglomerated sand descended slowly and as one piece. The P1 agglomerated sand was beige and fluffy. The P1 agglomerated sand formed a formable or reformable agglomerate that easily changed shape by the speed of mixing or the torque acting on the P1 agglomerated sand.

### Example 24—P2

165.61 g of a 25 wt. % solution of 15% partially oxidized poly-4-vinylpyridine, 9.28 g of Glycol Ether EB, and 9.26 g of ethylene glycol were weighed into a 400 mL beaker. These contents were stirred with a Calframo overhead stirrer for 10 minutes at 300 rpm. Then 16.00 g of Alpha 2240 from Weatherford was weighed into a plastic syringe and injected slowly at the beaker wall. The mixture was stirred for 90 minutes. The final product was a dark amber transparent liquid. The blend was designated P2.

200.01 g of 100 mesh sand were weighed into a 400 mL beaker. 200 mL of a 2 wt. % KCl solution were added to the sand. Meanwhile, 15.41 g of P2 were weighed into a plastic syringe. P2 was added incrementally to a vortex of the sand in the 2 wt. % KCl solution being stirred at 450 rpm with the Calframo overhead stirrer. The vortex disappeared as P2 was added to the sand in the KCL aqueous solution. Then mixture was stirred for an additional 60 s and the liquid decanted. 200 mL of the 2 wt. % KCl solution were added to the P2 agglomerated sand, stirred for 60 s and the liquid decanted. This washing step was repeated two more times. On the last washing step, the contents were poured into a 16 ounce bottle, topped off with additional 2 wt. % Kcl solution and capped. When the bottle was inverted, the P2 agglomerated sand descended slowly and as one piece. The P2 agglomerated sand was beige, fluffy and formed a formable or deformable agglomerate that easily changed shape by the speed of mixing or the torque acting on the P2 agglomerated sand.

### Example 25

200.02 g of 20/40 sand were weighed into a 400 mL beaker. 200 mL of a 2 wt. % KCl solution were added to the sand. Meanwhile, 15.44 g of P2 were weighed into a plastic syringe and added incrementally to the vortex of the sand in the 2 wt. % KCl solution being stirred at 450 rpm with the Calframo overhead stirrer. The vortex disappeared as P2 was added to the sand in the aqueous KCl solution. Then mixture was stirred for an additional 60 s and the liquid decanted.

200 mL of the 2 wt. % KCl solution were added to the P2 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the P2 agglomerated sand descended slowly and as one piece. The P2 agglomerated sand was beige and fluffy and forms a formable or deformable agglomerate that easily changed shape by the speed of mixing or the torque acting on the P2 agglomerated sand.

### Example 26—P3

165.64 grams of a 25 wt. % solution of 29% partially oxidized poly-4-vinylpyridine, 9.37 grams Glycol Ether EB and 10.11 grams ethylene glycol were weighed into a 400 mL beaker. The degree of oxidation of the 29% partially oxidized poly-4-vinylpyridine was measured by NMR. The concentration of the 29% partially oxidized poly-4-vinylpyridine solution was measured by Thermogravimetric Analysis (TGA). These contents were stirred with a Calframo overhead stirrer for 10 minutes at 300 rpm. Then 16.03 g of Alpha 2240 from Lubrizol Oilfield Solutions were weighed into a plastic syringe and injected slowly at the beaker wall. The mixture was stirred for 90 more minutes. The final product was a dark amber transparent liquid and designated P3.

### Example 27—P4

200 g of 100 mesh sand were weighed into a 400 mL beaker. 200 mL of a 2 wt. % KCl solution was added to the sand. Meanwhile, 14 mL of a 25 wt. % solution of 15% partially oxidized poly-4-vinylpyridine (P4) was added incrementally to a mixing vortex of the sand in the 2 wt. % KCl solution, which was being stirred at 450 rpm with the Calframo overhead stirrer. The vortex disappeared as the solution was added to the sand in the KCl solution. The mixture was then stirred for an additional 60 s and the liquid decanted from the sand. 200 mL of the 2 wt. % KCl solution were added to the P4 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the P4 agglomerated sand descended slowly and as one piece as compared to untreated sand, which fell as individual sand grains.

### Example 28—P5

200 g of 100 mesh sand were weighed into a 400 mL beaker. 200 mL of a 2 wt. % KCl solution was added to the sand. Meanwhile, 14 mL of a 25 wt. % solution of 29% partially oxidized poly-4-vinylpyridine (P5) was added incrementally to a mixing vortex of the sand in the 2 wt. % KCl solution, which was being stirred at 450 rpm with the Calframo overhead stirrer. The vortex disappeared as P5 was added to the sand in the KCl solution. The mixture was then stirred for an additional 60 s and the liquid decanted from the sand. 200 mL of the 2 wt. % KCl solution were added to the P5 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the P5 agglomerated sand descended slowly and as one piece as compared to untreated sand, which fell as individual sand grains.

### Resins and Cross-Linkers

### Example 29—R1

120 g of a 4-ethenylpyridine homopolymer, 33 g of dimethyl 2-methylglutarate and 33 g of ethylene glycol were weighed into a 400 mL beaker. These contents were stirred with a Calframo overhead stirrer for 10 minutes at 300 rpm. Then 6.5 g of acetic acid was weighed into a plastic syringe and injected slowly into the beaker. The mixture was stirred for 90 more minutes. The final product was an amber transparent liquid and is designated 1R.

### Example 30—R2

To 9.5 g of R1 was added 0.5 g phenolic resole resin and mixed in a bottle until a uniform solution was formed. The final product was an amber transparent liquid and is designated R2.

### Example 31—Measurement of Compressive Strength

Agglomerated 25 g of 100 mesh sand using 5 mL of R2 in 50 mL 2% KCl solution followed by 1 wash with 50 mL 2% KCl. Next, 20 g of this sample was placed into a 1″ cement mold and pressed to 500 psi to make a uniform sample. This sample was immersed in a 2% KCl solution which was placed in a water bath at 180° F. for 3 days. The sample was then cooled to room temperature, removed from the mold, and the compressive strength measured using a Texture Technologies TA-HDPlus instrument. Compressive strength was measured at 1100 psi.

### Example 32—R3

To 8.5 g of a solution with formulation similar to AC16 was added 1.5 g of bisphenol A diglycidyl ether and the mixture shaken until a uniform solution was formed. The final product as a dark black, uniform solution and is designated R3.

### Example 33—Measurement of Compressive Strength

Next, 40 g of 100 mesh sand in 40 mL 2% KCl was agglomerated with 2.8 mL of R3 followed by 3 post-flushes with 40 mL 2% KCl. Next, 20 g of this sample was placed into a 1″ cement mold and pressed to 500 psi to make a uniform sample. This sample was immersed in a 2% KCl solution which was placed in a water bath at 180° F. for 1 day. The sample was then removed from the mold, and the compressive strength was immediately measured. Compressive strength was measured at 546 psi.

### Example 34—R4

92 g of a 4-ethenylpyridine homopolymer, 46 g of a glycol ether and 46 g of ethylene glycol were weighed into a 400 mL beaker. These contents were stirred with a Calframo overhead stirrer for 10 minutes at 300 rpm. Then 2.2 g of acetic acid was weighed into a plastic syringe and injected slowly into the beaker. The mixture was stirred for 90 more minutes. The final product was an amber transparent liquid and is designated R4.

### Example 35—R5

To 9.75 g of R4 was added 0.25 g 1,6-dibromohexane and the mixture shaken until a uniform solution was formed. The final product was an amber transparent liquid and is designated R5.

### Example 36

Agglomerated 25 g of 100 mesh sand using 5 mL of R5 in 50 mL 2% KCl solution followed by 1 wash with 50 mL 2% KCl. Next, 20 g of this sample was placed into a 1″ cement mold and pressed to 500 psi to make a uniform sample. This sample was immersed in a 2% KCl solution which was placed in a water bath at 180° F. for 1 day. The sample was then removed from the mold and the compressive strength was immediately measured. Compressive strength was measured at 113 psi.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

1. An aggregating composition comprising:
one reaction product or a plurality of reaction products of:
(a) at least one nitrogen-containing compound, wherein the nitrogen-containing compounds include: (a) one amine or a plurality of amines, (b) one epoxy-modified amine or a plurality of epoxy-modified amines, (c) one oligomeric amine (oligoamine) or a plurality of oligomeric amines (oligoamines), (d) one epoxy-modified oligoamine or a plurality of epoxy-modified oligoamines, (e) one polymeric amine (polyamine) or a plurality of polymeric amines (polyamines), (f) one epoxy-modified polyamine or a plurality of epoxy-modified polyamines (g) one amine containing polymer or a plurality of amine containing polymers, (h) one epoxy-modified amine containing polymer or a plurality of epoxy-modified amine containing polymers, (i) one reaction product of at least one epoxy containing compound and at least one nitrogen-containing compound or a plurality of reaction products of at least one epoxy containing compound and at least one nitrogen-containing compound; (j) one biopolymer or a plurality of biopolymers, (k) one epoxy-modified biopolymer or a plurality of epoxy-modified biopolymers, and (l) mixtures or combinations thereof and
(b) at least one amine reactive compound selected from: (1) one acidic hydroxyl containing compound or a plurality of acidic hydroxyl containing compounds, (2) one homo and mixed anhydride of acidic hydroxyl containing compounds or a plurality of homo and mixed anhydride of acidic hydroxyl containing compounds; (3) one Lewis acid or a plurality of Lewis acids, or (4) mixtures and combinations thereof,
where the composition forms a partial, substantially complete, and/or complete coating of surfaces of solid materials modifying, altering and/or changing an aggregating propensity and/or zeta potential of the solid materials so that the coated solid materials have improved self-aggregating properties.

2. (canceled)

3. (canceled)

4. A method for changing an aggregation potential or propensity of a solid material comprising the step of
contacting the solid material with the composition of claim 1.

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. The composition of claim 1, further comprising:
at least one of poly-glycidyl ethers, hydrocarbylhalides, bisphenol A, polyisocyanates, diacyl azides, cyanuaric chloride, diacids, polyacids, imidylated di and poly carboxylic acids, anhydrides, carbonates, polyepoxides, polyaldehydes, polyisothioisocyanates, polyvinylsulfones, silane crosslinking compounds, or mixtures or combinations thereof.

17. The composition of claim 16, where the glycidyl ether or diglycidyl ether are selected from diglycidyl ether of bisphenol A, DER 330 epoxy resin, butyl glycidyl ether, C₈-C₁₀ glycidyl ether, C₁₂-C₁₄ glycidyl ether, and mixtures or combinations thereof.

18. The composition of claim 1, further comprising:
a reaction product of amines, polyamines, and/or amine polymers and phosphorus containing compounds.

19. The composition of claim 1, wherein:
the amine comprises amines having the general formula R¹R²NH, R¹R²R³N, or mixtures and combinations thereof,
the oligoamine comprises oligomers including at least one amino group of the general formula NR¹R²,
the polyamine comprises polymers including at least one amino group of the general formula NR¹R²,
the epoxy modified amine, oligoamines, and/or polyamines including at least one epoxy group,
where R³, R² and R³ are independently a hydrogen atom or a hydrocarbyl group having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof, and
chitosans, polypeptides including at least one amino acid selected from the group consisting of lysine, tryptophan, histidine, arginine, asparagine, glutamine, and mixtures or combinations thereof, protein containing gelatins, and mixtures or combinations thereof.

20. (canceled)

21. The composition of claim 1, wherein:
the acidic hydroxyl compound comprises a mineral acid, an organic acid, of mixtures and combinations thereof,
homo or mixed anhydrides comprise homo and mixed anhydrides of mineral acids, organic acids, or mixtures and combinations thereof; and
the Lewis acid comprises a metal compound and mixtures or combinations thereof, where the metal is selected from the group consisting of groups 2-17 metals and mixture or combinations thereof.

22. The composition of claim 21, wherein:
the group 2 metal compounds include compounds of Be, Mg, Ca, Sr, and Ba;
the group 3 metal compounds include compounds of Sc, Y, La and Ac;
the group 4 metal compounds include compounds of Ti, Zr, Hf, Ce, and Th;
the group 5 metal compounds include compounds of V, Nb, Ta, and Pr;
the group 6 metal compounds include compounds of Cr, Mo, W, Nd, and U;
the group 7 metal compounds include compounds of Mn, Tc, Re, and Pm
the group 8 metal compounds include compounds of Fe, Ru, Os, and Sm;
the group 9 metal compounds include compounds of Co, Rh, Ir, and Eu;
the group 10 metal compounds include compounds of Ni, Pd, Pt, and Gd;
the group 11 metal compounds include compounds of Cu, Ag, Au, and Tb;
the group 12 metal compounds include compounds of Zn, Cd, Hg, and Dy;
the group 13 metal compounds include compounds of Al, Ga, In, Tl, and Ho;
the group 14 metal compounds include compounds of Si, Ge, Sn, Pb, and Er;
the group 15 metal compounds include compounds of As, Sb, Bi, and Tm;
the group 16 metal compounds include compounds of Yb;
the group 17 metal compounds include compounds of Lu;
the counterions are selected from the group consisting of halides, oxyhalides, tetrahaloboranes, carbonates, oxides, sulfates, hydrogensulfates, sulfites, hydrosulfites, hexahalophosphates, phosphates, hydrogenphosphates, phosphites, hydrogenphosphites, nitrates, nitrites, carboxylates, hydroxides, any other counterion, and mixtures or combinations thereof.

23. The composition of claim 21, wherein:
the minerals acid include phosphoric acid, sulfur acid, hydrochloric acid, hydrobromic acid, nitric acid, boric acid, or mixtures and combinations thereof,
the organic acid include monocarboxylic acids, dicarboxylic acids, polymeric carboxylic acids, homo and mixed anhydrides thereof, and mixtures or combinations thereof, where the carboxylic acids include from about 1 to about 40 carbon atoms, and mixtures or combinations thereof.

24. (canceled)

25. (canceled)

26. The composition of claim 1, wherein the solid material is selected from the group consisting of natural or synthetic metal oxides and/or ceramics, metals, shale, REV dust, plastics, polymeric solids, solid materials derived from plants, and mixtures or combinations thereof.

27. (canceled)

28. (canceled)

29. (canceled)

30. The composition of claim 1 wherein the one or more reaction products further include a resin.

31. The composition of claim 30, wherein the resin comprises at least one of a two component epoxy based resin, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, cyanate esters, polyurethane resins and hybrids and copolymers thereof, acrylate resins, and mixtures thereof.

32. The composition of claim 1 further comprising at least one of a tackifying compound or a hydrophobically modified compound.

33. The composition of claim 1, wherein the amine reactive compound further comprises at least one phosphate-containing compound or a plurality of phosphate-containing compounds in conjunction with one of the other amine reactive compounds.
